(19) United States
(12) Patent Application Publication
(10) Pub. No.: US 2024/0072644 A1
(43) Pub. Date: Feb. 29, 2024

(54) CONTROLLER FOR SWITCHING CONVERTERS

(71) Applicant: TEXAS INSTRUMENTS INCORPORATED, Dallas, TX (US)

(72) Inventors: Branko MAJMUNOVIC, Dallas, TX (US); Johan STRYDOM, Saratoga, CA (US); Brent MCDONALD, Murphy, TX (US)

(21) Appl. No.: 18/162,410

(22) Filed: Jan. 31, 2023

Related U.S. Application Data
(60) Provisional application No. 63/401,993, filed on Aug. 29, 2022.

(51) Int. Cl. H02M 1/38; H02M 1/00; H02M 3/335

(52) U.S. Cl. CPC H02M 1/385; H02M 1/0058; H02M 3/33569

(57) ABSTRACT

A controller circuit is configured to receive a measurement signal representing a power converter state and receive a control signal representing a power converter resonant period. Based on the power converter state and the power converter resonant period, the controller circuit determines for a switching cycle: a charging interval, a first dead time interval, a discharging interval, and a second dead time interval. The first dead time interval is after the charging interval. The discharging interval is after the first dead time interval. The second dead time interval is after the discharging interval. The controller circuit provides a first drive signal and a second drive signal based on the charging interval, the first dead time interval, the discharging interval, and the second dead time interval.

### CROSS-REFERENCE TO RELATED APPLICATIONS

This application claims priority to U.S. Provisional Application No. 63/401,993, filed Aug. 29, 2022, entitled “90 Degrees Valley Unified Controller for Zero-Voltage-Switching Quasi-Square-Wave (ZVS-QSW) Converters,” which is hereby incorporated by reference.

### BACKGROUND

A power supply system can transfer electric power from an alternating current (AC) source to a load. The power supply system can rectify an AC voltage to generate a direct current (DC) voltage. The power supply system can also include a power converter, such as a switch mode power converter, to regulate the DC voltage at a target DC voltage, and provide the regulated DC voltage to the load. The power supply system may employ various techniques to improve the efficiency of electric power transfer, such as reducing the phase delay between an AC current drawn from the AC source and the AC voltage, and reducing the power loss during the switching of the power converter.

### SUMMARY

In one example, an apparatus includes a controller circuit having first and second control inputs, and first and second control outputs. The controller circuit is configured to: 1) at the first control input, receive a measurement signal representing a power converter state; 2) at the second control input, receive a control signal representing a power converter resonant period; 3) based on the power converter state and the power converter resonant period, determine: a charging interval of a switching cycle; a first dead time interval of the switching cycle; a discharging interval of the switching cycle, and a second dead time interval of the switching cycle, in which the first dead time interval is after the charging interval, the discharging interval is after the first dead time interval, and the second dead time interval is after the discharging interval; 4) within the switching cycle, provide a first drive signal at the first control output, and provide a second drive signal at the second control output. Within the charging interval, the first drive signal has a first state, and the second drive signal has a second state. Within the first and second dead time intervals, the first and second drive signals have the second state. Within the discharging interval, the first drive signal has the second state, and the second drive signal has the first state.

In another example, a method includes: 1) receiving a measurement signal representing a power converter state; 2) receiving a control signal representing a power converter resonant period; 3) determining, based on the power converter state and the power converter resonant period: a charging interval of a switching cycle; a first dead time interval of the switching cycle; a discharging interval of the switching cycle; and a second dead time interval of the switching cycle, in which the first dead time interval is after the charging interval, the discharging interval is after the first dead time interval, and the second dead time interval is after the discharging interval; and 4) providing, within the switching cycle, a first drive signal and a second drive signal. Within the charging interval, the first drive signal has a first state, and the second drive signal has a second state. Within the first and second dead time intervals, the first and second drive signals have the second state. Within the discharging interval, the first drive signal has the second state, and the second drive signal has the first state.

In a further example, an apparatus includes a power converter and a controller circuit. The a power converter having a positive input, a negative input, a positive output, and a negative output. The power converter includes a first switch, a second switch, and an inductor. The first switch and the second switch are coupled in series between the positive and negative outputs. A first current terminal of the first switch is coupled to a second current terminal of the second switch and the inductor. The controller circuit is configured to: 1) receive a measurement signal representing a state of the power converter; 2) receive a control signal representing a resonant period of the power converter; 3) determine, based on the state of the power converter and resonant period of the power converter: a charging interval of a switching cycle of the power converter; a first dead time interval of the switching cycle; a discharging interval of the switching cycle; and a second dead time interval of the switching cycle, in which the first dead time interval is after the charging interval, the discharging interval is after the first dead time interval; and the second dead time interval is after the discharging interval; and 4) within the switching cycle, provide a first drive signal to the first switch, and provide a second drive signal to the second switch. Within the charging interval, the first drive signal has a first state, and the second drive signal has a second state. Within the first and second dead time intervals, the first and second drive signals have the second state. Within the discharging interval, the first drive signal has the second state, and the second drive signal has the first state.

### BRIEF DESCRIPTION OF THE DRAWINGS

FIG. 1 is a schematic diagram of an example electric power transfer system.

FIG. 2 are waveform diagrams that illustrate examples of phase relationships between input voltage and input current of the electric power transfer system of FIG. 1.

FIG. 3 is a schematic diagram of an example power supply system that can be part of the electric power transfer system of FIG. 1.

FIG. 4 and FIG. 5 include waveform diagrams that illustrate example operations of the power supply system of FIG. 3.

FIG. 6 is a schematic diagram of an example power supply system that can be part of the electric power transfer system of FIG. 1.

FIGS. 7 through 9 are waveform diagrams that illustrate example operations of the power supply systems of FIG. 3 and FIG. 6.

FIG. 10 is a schematic diagram of an example power supply system that can be part of the electric power transfer system of FIG. 1.

FIG. 11 is a block diagram that illustrates examples of internal components of the power supply system of FIG. 10.

FIG. 12A includes waveform diagrams that illustrate current and voltage in the power supply system of FIG. 10.

FIG. 12B is a state plane diagram that illustrates a relationship of the voltage and current waveforms of FIG. 12A.

FIG. 13 is a block diagram of an example of a generalized interval computation circuit illustrated in FIG. 11.

FIG. 14 is a block diagram of an example interval computation circuit that includes switching frequency compensation.

FIG. 15 is a block diagram of an example compensation circuit that can be part of the interval compensation circuit of FIG. 14.

FIG. 16 is a block diagram of an example interval computation circuit that includes an example switching frequency compensation circuit.

FIG. 17 is a block diagram of an example switching frequency compensation circuit that can be part of the interval compensation circuit of FIG. 14.

FIG. 18 is a flow diagram for an example method of switching period adjustment that can be implemented by the interval computation circuit of FIG. 11.

FIG. 19 is a flow diagram for an example method of adaptive gain adjustment that can be implemented by the interval computation circuit of FIG. 11.

FIG. 20 is a block diagram of example compensation circuitry 2000 that can be part of the interval computation circuit of FIG. 11.

FIG. 21 is a block diagram of an example interval computation circuit that includes an example inductor current compensation circuit.

FIGS. 22 and 23 are block diagrams of example inductor current compensation circuitry that can be used in the interval computation circuit of FIG. 21.

FIG. 24 is a block diagram of an example time constant estimator circuit that can provide inputs to the example interval computation circuit of FIG. 11.

FIGS. 25-27 include schematic and waveform diagrams that illustrate examples of internal components of the power supply system of FIG. 10 and their operations.

FIG. 28 is a chart that illustrates example operations of the power supply system of FIG. 10.

FIG. 29 is a block diagram that illustrates an example hardware system that be part of the example power supply system of FIGS. 1 through 25.

FIG. 30 is a flowchart that illustrates an example method of controlling a power converter.

### DETAILED DESCRIPTION

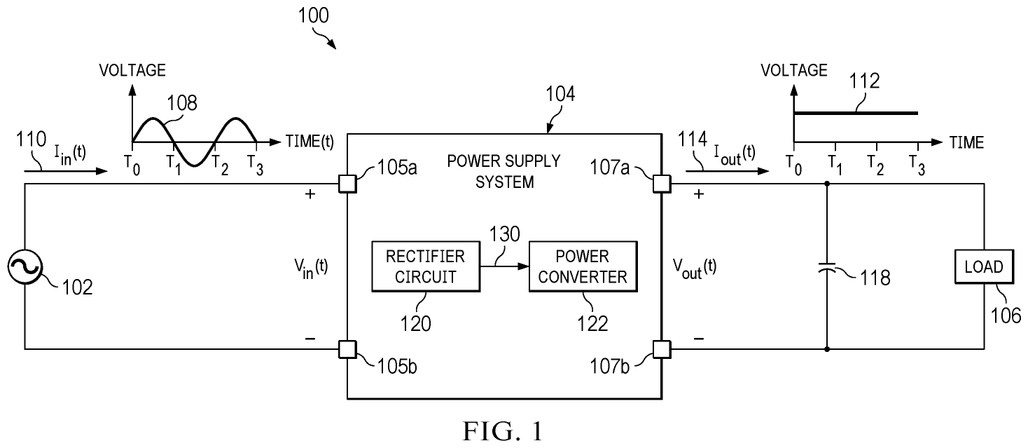

FIG. 1 is a schematic diagram that illustrates an example of an electric power transfer system 100. The electric power transfer system 100 may include an AC power source 102, a power supply system 104, and a load 106. Power supply system 104 can include a positive input 105a, a negative input 105b, a positive output 107a, and a negative output 107b. AC power source 102 can provide an AC input voltage signal 108 (labelled Vᵢₙ(t)) across positive input 105a and negative input 105b. AC input voltage signal 108 can have positive half-cycles when the voltage signal is positive (e.g., between T₀ and T₁ and between T₂ and T₃) and negative half-cycles when the voltage signal is negative (e.g., between T₁ and T₂). In the positive half-cycles, positive input 105a can receive a higher voltage than negative input 105b, and in the negative half-cycles, the polarities are reversed and positive input 105a can receive a lower voltage than negative input 105b. An AC input current signal 110 (labelled Iᵢₙ(t)) can also flow into positive input 105a and return back to AC power source 102 from negative input 105b in the positive half-cycles of AC input voltage signal 108. The AC input current signal can also flow into negative input 105b and return back to AC power source 102 from positive input 105a in the negative half-cycles of AC input voltage signal 108.

From AC input voltage signal 108, power supply system 104 can generate a DC output voltage signal 112 (labelled Vₒᵤₜ(t)) across positive output 107a and negative output 107b. Positive output 107a can provide a positive power supply rail, and negative output 107b can provide a negative power supply rail. Power supply system 104 can supply DC output voltage signal 112 to load 106, which can include electronic components that operate on a DC voltage. Power supply system 104 can also provide an output DC current signal 114 (labelled Iₒᵤₜ(t)), which can flow out of positive output 107a, through load 106, and return back to negative output 107b. Electric power transfer system 100 can include a capacitor 118 to perform a filtering operation to reduce the ripples in DC output voltage signal 112 and output DC current signal 114.

To generate DC output voltage signal 112 from AC input voltage signal 108, power supply system 104 can include a rectifier circuit 120 and a power converter circuit 122. Rectifier circuit 120 can perform a rectification operation to convert AC input voltage signal 108 to a DC input voltage signal 130. As part of the rectification operation, rectifier circuit 120 can pass the positive voltages of AC input voltage signal 108 during the positive half cycles as the DC input voltage signal 130. Rectifier circuit 120 can also block the negative voltages of AC input voltage signal 108 during the negative half cycles in a half-wave rectification operation, or convert the negative voltages to positive voltages in a full-wave rectification operation, and generate a pulsating DC input voltage signal 130. Power converter circuit 122 can then generate DC output voltage signal 112 from DC input voltage signal 130 based on a conversion ratio. In a case where power converter circuit 122 is a step-up converter (e.g., a boost converter), the conversion ratio can be higher than one, and DC output voltage signal 112 can become higher than DC input voltage signal 130. In a case where power converter circuit 122 is a step-down converter (e.g., a buck converter), the conversion ratio can be lower than one, and DC output voltage signal 112 can become lower than DC input voltage signal 130.

In addition to generating DC output voltage signal 112, power converter circuit 122 may perform a power factor correction operation. Power factor can be defined as a ratio of the real power measured in watts (W) consumed by load 106 divided by the total apparent power measured in volt-amperes (VA) circulating between AC power source 102 and load 106. A high power factor (close to one) can indicate that a large percentage of the power supplied by AC power source 102 (apparent power) is delivered to and consumed by load 106. The power factor correction operation can be performed to increase the power factor up to one.

Power factor (PF) can be given by a phase relationship φ between AC input voltage signal 108 and AC input current signal 110 according to the following Equation:

PF=cos (y) (Equation 1)

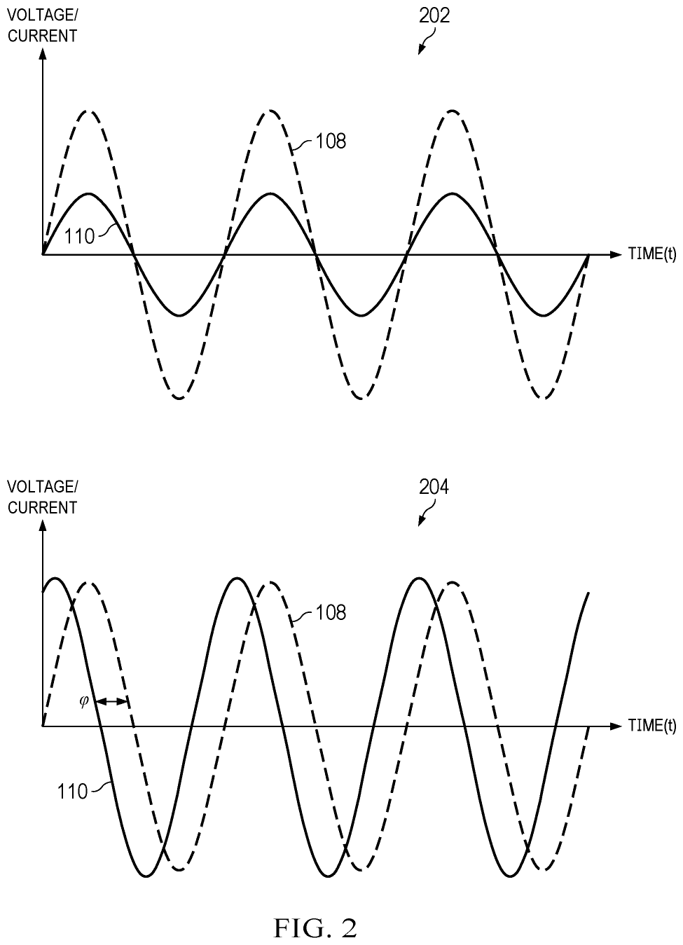

FIG. 2 illustrates charts 202 and 204 of example phase relationship φ between AC input voltage signal 108 and AC input current signal 110 and the corresponding power correction factors. In chart 202, AC input voltage signal 108 and AC input current signal 110 has a zero phase difference, which can lead to a power factor of one. In chart 204, AC input voltage signal 108 and AC input current signal 110 has a phase difference of φ, and the power factor can become lower than one. As shown in FIG. 2, the amplitude of AC input current signal 110 in chart 204 (with a reduced power factor) is increased, so that the same amount of power can be consumed by load 106 as in chart 202 where the power factor is one. Accordingly, increasing the power factor can improve the efficiency of power transfer by power supply system 104.

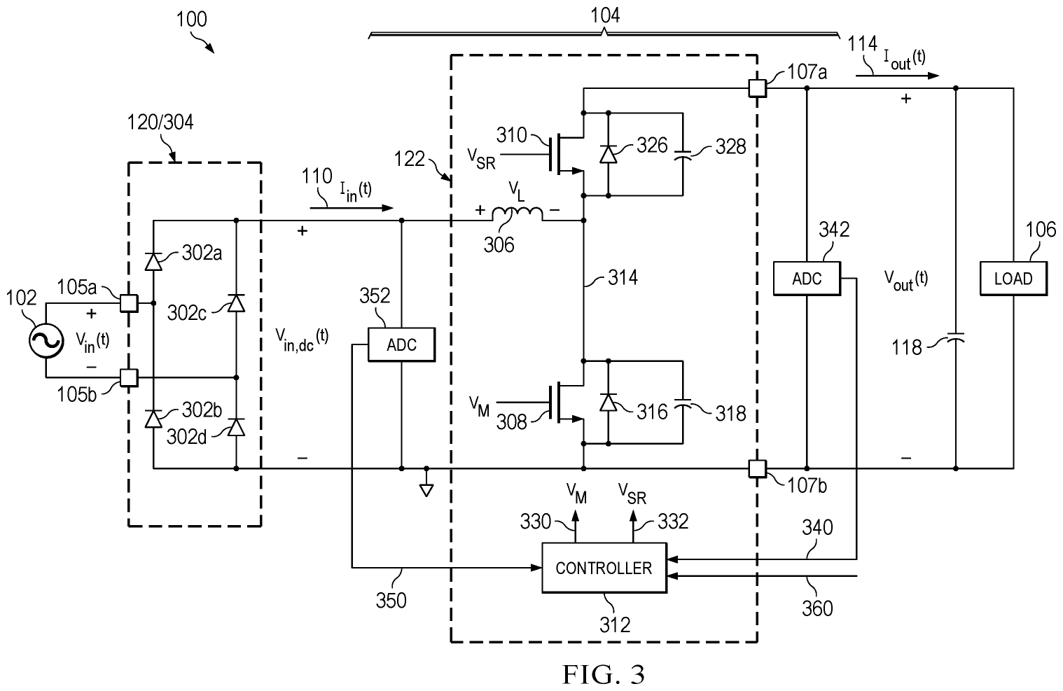

FIG. 3 is a schematic diagram of an example power supply system 104. Referring to FIG. 3, power supply system 104 can include diodes 302a, 302b, 302c, and 302d coupled between positive input 105a and negative input 105b forming a diode bridge 304. Diode bridge 304 can be part of rectifier circuit 120 and can perform a full-wave rectification operation to generate a pulsating DC input voltage signal 130 from AC input voltage signal 108. Also, power converter circuit 122 can include an inductor 306, a switch 308, a switch 310, and can be coupled to a controller 312 that controls switches 308 and 310. Inductor 306 and switches 308 and 310 can be coupled at a node 314, and switches 308 and 310 can be coupled in series between positive output 107a and negative output 107b. The voltage of node 314 can switch between the positive and negative power supply rails within a switching cycle and can be a switching node. In FIG. 3, negative output 107b can be coupled to a ground. In other examples, negative output 107b can be coupled to a low impedance voltage source to provide a reference voltage and to provide a return path for output DC current signal 114.

Inductor 306 and switches 308 and 310 can be configured as a boost converter. Switch 308 can be a main switch to control the flow of AC input current signal 110 through inductor 306 to store magnetic energy in the inductor. Switch 310 can be a synchronized rectifier (SR). When enabled, switch 310 allows inductor 306 to discharge to supply a current to load 106. Also, when switch 310 is disabled, the body diode of switch 310 can block the flow of current from load 106 back to inductor 306. Each of switches 308 and 310 can include a transistor, such as a silicon field effect transistor (FET), or a gallium nitride (GaN) high electron mobility transistor (HEMT). In the example shown in FIG. 3, each of switches 308 and 310 can be an n-channel FET (NFET). Each switch can include a body diode and parasitic capacitances. In FIG. 3, a diode 316 and a capacitor 318 can represent the respective body diode and parasitic capacitance of switch 308, and a diode 326 and a capacitor 328 can represent the respective body diode and parasitic capacitance of switch 310.

Controller 312 can generate control signal 330 (labelled V_{M} in FIG. 3) to enable/disable main switch 308 in each switching cycle. Controller 312 can also generate control signal 332 (labelled V_{SR} in FIG. 3) to enable/disable SR switch 310 in each switching cycle. Controller 312 can receive measurements 340 of the magnitude of DC output voltage signal 112 (Vₒᵤₜ(t)) (see FIG. 1) from a measurement circuit 342 (e.g., an analog-to-digital converter (ADC)), measurements 350 of the magnitude of DC input voltage signal 130 (V_{in,dc}(t)) output by rectifier circuit 120 from a measurement circuit 352 (e.g., an ADC), and a reference DC output voltage 360. Controller 312 can control the timings and durations of control signals V_{M} and V_{SR} based on the measurements and the reference to achieve a target value of the DC output voltage signal 112. Also, controller 312 can determine the duration of control signals V_{M} and V_{SR} based on measurements of AC input voltage signal 108 to reduce the phase difference between AC input voltage signal 108 and AC input current signal 110, reduce harmonic distortion in the AC input current signal 110, and improve the power factor. Throughout the switching cycles, a voltage V_{L} can develop across inductor 306, which can affect AC input current signal 110 as well as DC output voltage signal 112.

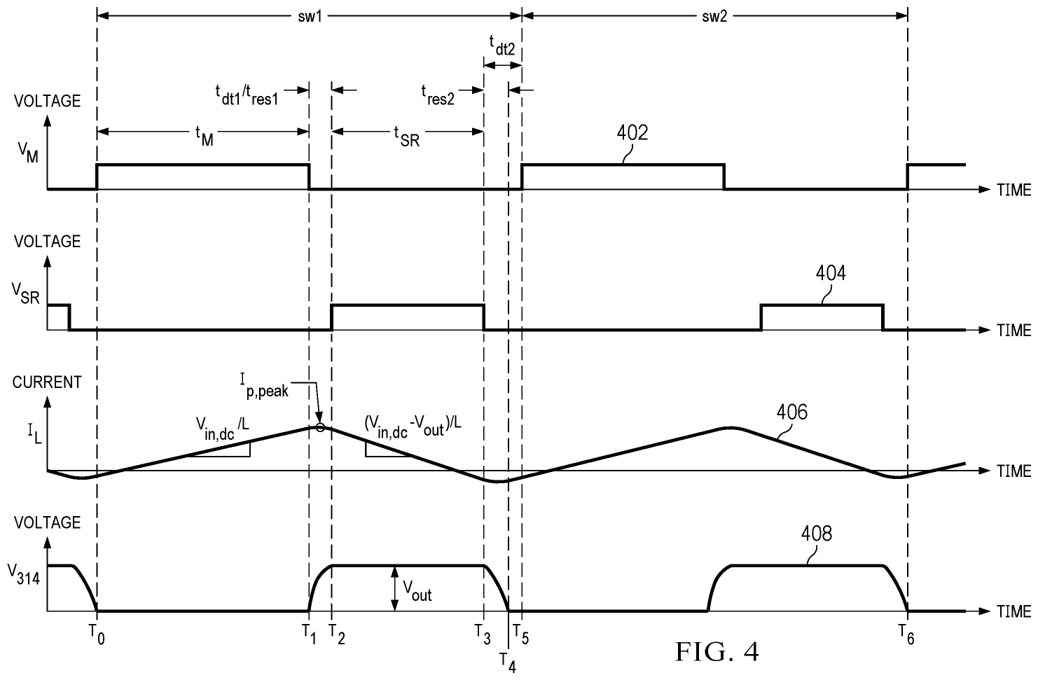

FIG. 4 includes include waveform diagrams that illustrate example operations of power converter circuit 122 of FIG. 3. FIG. 4 includes graphs 402, 404, 406, and 408. Graph 402 illustrates the variation of control signal 330 (V_{M}) with respect to time, and graph 404 illustrates the variation of control signal 332 (V_{SR}) with respect to time, both controlled by controller 312. Also, graph 406 illustrates the variation of inductor current that flows through inductor 306 with respect to time, and graph 408 illustrates the variation of voltage of node 314 with respect to time.

A first switching cycle (sw1) starts at time T₀. Between T₀ and T₁ can be a first charging interval, in which controller 312 provides a V_{M} signal at a first state to enable main switch 308, and provides a V_{SR} signal at a second state to disable SR switch 310. The first state may be opposite to the second state. In a case where main switch and SR switch 310 are NFETs, the V_{M} and V_{SR} signals at the first state can each be a gate voltage that exceeds the source voltage by at least a conduction threshold of the NFET, and the V_{M} and V_{SR} signals at the second state can each be a gate voltage that is below a sum of the source voltage and the conduction threshold. With main switch 308 enabled, the voltage of node 314 can be brought to ground, and the voltage V_{L} across inductor 306 can be equal to DC input voltage signal 130 (V_{in,dc}). Inductor 306 can be charged within the first charging interval between T₀ and T₁, and an increasing positive charging current that charges inductor 306 can flow from inductor 306 towards switch 308. Diode 326 is reverse-biased and can prevent current from flowing from load 106/capacitor 118 back to switch 308 and ground. With inductor 306 having an inductance L, the inductor current I_{L}, which can be equal to AC input current signal 110 (Iᵢₙ(t)) from AC power source 102, can increase based on the following Equation:

$$\frac{{dI}_{L}}{dt} = \frac{{V}_{L}}{L} = \frac{{V}_{in , dc}}{L} \qquad ( Equation 2 )$$

In Equation 2, as DC input voltage signal 130 (V_{in,dc}) is positive, the slope of inductor current

$$\frac{{dI}_{L}}{dt}$$

is also positive, and the inductor current increases between times T₀ and T₁. The positive inductor current can peak (or be near peak) at time T₁. With the duration between times T₀ and T₁ equal to t_{M}, which represents the duration of the turn-on interval of main switch 308 in which main switch 308 is enabled, a positive peak inductor current I_{p,peak} at time T₁ can be related to V_{in,dc} and t_{M} based on the following Equation:

$${I}_{p , peak} = \frac{{V}_{in , dc}}{L} \times {t}_{M} \qquad ( Equation 3 )$$

Between T₁ and T₂ can be a first dead time interval in which controller 312 can set both V_{M} and V_{SR} signals to the second state to disable the respective switches 308 and 310. The duration between T₁ and T₂ (labelled t_{dt1}) can include a first resonant interval (labelled tᵣₑₛ₁) of the switching cycle in which inductor 306 resonates with capacitors 318 and 328. During the first resonant interval, inductor current from inductor 306 can charge capacitor 318 and discharge capacitor 328, and the voltage of node 314 can increase until it is clamped by diode 326 of switch 310 to the positive power supply rail (e.g., Vₒᵤₜ). Accordingly, t_{dt1} can be or can include a peak resonant transition interval. As the peak inductor current is used to charge capacitor 318 and discharge capacitor 328, tᵣₑₛ₁ can be relatively short.

Between T₂ and T₃ can be a discharging interval, in which controller 312 can set V_{M} signal to the second state to continue disabling main switch 308, and set V_{SR} signal to the first state to enable SR switch 310. Inductor 306 dissipates the stored magnetic energy to supply a discharging current to load 106 and capacitor 118. With node 314 at Vₒᵤₜ, the inductor voltage V_{L} becomes V_{in,dc}−Vₒᵤₜ, and the rate of change of inductor current becomes:

$$\frac{{dI}_{L}}{dt} = \frac{{V}_{L}}{L} = \frac{{V}_{in , dc} - {V}_{out}}{L} \qquad ( Equation 4 )$$

As V_{in,dc} is lower than Vₒᵤₜ in a step-up conversion operation, V_{L} becomes negative, and inductor 306 is discharged to supply a current to load 106 and/or capacitor 118. The inductor current, as well as input current Iᵢₙ(t), can reduce linearly from the positive peak current (I_{p,peak}) between T₂ and T₃ due to negative

$$\frac{{dI}_{L}}{dt} .$$

The inductor current may continue to drop between T₂ and T₃ and become negative. The negative inductor current can flow towards AC power source 102, remove charge from capacitor 318 of main switch 308, and add charge to capacitor 328 of SR switch 310. The duration between T₂ and T₃ equals t_{SR}, which represents the turn-on interval of SR switch 310 in which the SR switch is enabled. The negative discharging current of the inductor when SR switch 310 is disabled can be an SR turn-off current.

The SR turn-off current can be based on the positive peak charging current, the inductance of inductor 306 that sets the rate of reduction of the inductor current, and the duration of turn-on interval of SR switch 310 t_{SR}. In some examples, controller 312 can determine t_{SR} based on determining the SR turn-off current needed to remove the charge of capacitor 318 of main switch 308 and add charge to capacitor 328 of SR switch 310 in a subsequent resonant interval. With such arrangements, node 314 can drop to the negative power supply rail (e.g., ground) prior to main switch 308 being enabled again. As the voltage across main switch 308 is zero (or lower than zero) when the state of main switch 308 is switched, zero voltage switching (ZVS) can be achieved, which can reduce power loss during the switching of main switch 308.

In some examples, controller 312 can determine t_{SR}based on comparing DC input voltage signal 130 (V_{in,dc}) and DC output voltage signal 112 (Vₒᵤₜ). The DC input voltage can affect the positive peak inductor current (I_{p,peak}) and the amount of charge stored in capacitor 318 of main switch 308, which in turn can affect the amount of SR turn-off current needed to discharge capacitor 318 and bring the voltage of node 314 to ground in the second resonant interval. If V_{in,dc} is equal to or less than half of Vₒᵤₜ, a zero SR turn-off current may be sufficient. But if V_{in,dc} exceeds half of Vₒᵤₜ, controller 312 can extend the turn-on interval t_{SR} of SR switch 310 such that the SR turn-off current is a negative current (e.g., flows towards AC power source 102). Controller 312 can determine the minimum SR turn-off current, and when to disable SR switch 310, based on V_{in,dc}, Vₒᵤₜ, the inductance of inductor 306, and the total capacitances of capacitors 318 and 328.

Between T₃ and T₅ can be a second dead time interval in which controller 312 can set both V_{M} and V_{SR} signals to the second state to disable both switches 308 and 310. The duration of the second dead time interval (labelled t_{dt2}) can include a second resonant interval (tᵣₑₛ₂) of the switching cycle, between T₃ and T₄, in which inductor 306 and capacitors 318 and 328 form a resonant system. During the second resonant interval, the negative inductor current can remove charge from capacitor 318 of main switch 308 and add charge to capacitor 328 of SR switch 310. This causes the voltage of node 314 to drop to ground due to resonation. Accordingly, t_{dt2} can be or can include a valley resonant transition interval. Controller 312 can determine tᵣₑₛ₂ based on the SR turn-off current, V_{in,dc}, Vₒᵤₜ, and the resonant frequency, which can be based on the total capacitances of capacitors 318 and 328 and the inductance of inductor 306. The voltage of node 314 can drop to the negative power supply rail (e.g., ground in FIG. 3) at the end of the second resonant interval at time T₄.

Between T₄ and T₅ can be part of a second charging interval as the voltage of node 314 drops to ground and becomes lower than V_{in,dc}, a positive inductor voltage V_{L} can be induced across inductor 306. The inductor current can flow through diode 316 of main switch 308. Inductor 306 can be charged between T₄ and T₅, and the polarity of the inductor current may change during the second charging interval, or can depend on the initial condition at T₄.

At T₅, controller 312 can set V_{M} signal to the first state to enable main switch 308 and start a new switching cycle sw2, which ends at time T₆. At T₅ as the voltage across main switch 308 is zero when enabled, zero voltage switching (ZVS) can be achieved, which can reduce power dissipation caused by the enabling/disabling of main switch 308 and further improve the efficiency of power converter circuit 122.

As the average inductor voltage V_{L} in steady state equals zero, the DC input voltage signal 130 (V_{in,dc}) and the DC output voltage signal 112 (Vₒᵤₜ) can be related to the turn-on interval of main switch 308 (t_{M}) and the turn-on interval of SR switch 310 (t_{SR}) as follows:

V_{in,dc}×t_{M}+(V_{in,dc}−Vₒᵤₜ)×t_{SR}=0 (Equation 5)

From Equation 5, DC output voltage signal 112 (Vₒᵤₜ) can be related to DC input voltage signal 130 (V_{in,dc}) based on the following Equation:

$$\frac{{V}_{out}}{{V}_{in , dc}} = 1 + \frac{{t}_{M}}{{t}_{SR}} \qquad ( Equation 6 )$$

Referring again to FIG. 3, controller 312 can receive measurements 350 of DC input voltage signal 130, measurements 340 of DC output voltage signal 112, and reference DC output voltage 360 at the beginning of a switching cycle, and set t_{M} and t_{SR} of that switching cycle based on the measurements and Equation 6. For example, controller 312 can include a proportional integration (PI) controller that integrates a difference between DC output voltage signal 112 and reference DC output voltage 360, and determines t_{M} and t_{SR} of that switching cycle based on comparing the integrated difference and DC input voltage signal 130 as in Equation 6.

Also, controller 312 can set the t_{M} and/or t_{SR} of each switching cycle for a power factor correction operation. In some examples, controller 312 can set the t_{M} and/or t_{SR} to operate power converter circuit 122 in a critical conduction mode (CRM), where controller 312 enables main switch 308 when inductor current is at (or close to) zero at the start of each switching cycles, as shown in FIG. 4. Critical conduction mode can provide various advantageous. For example, as main switch 308 is enabled and SR switch 310 are disabled when inductor current is zero, zero current switching (ZCS) can be achieved, which can reduce power dissipation caused by the enabling/disabling of the switches and improve the efficiency of power converter circuit 122. Moreover, because no current flows through SR switch 310 when it is disabled, diode 326 of SR switch 310 need not have a fast recovery time, which allows SR switch 310 to be implemented with a relatively low bandwidth device and/or allows power converter circuit 122 to operate at a higher switching frequency.

FIG. 5 includes a chart 502 that illustrates a CRM operation by controller 312 over a half cycle of AC input voltage signal 108. Chart 502 includes graphs 504, 506, 508, 510, 512, and 514. Graph 504 represents reference DC output voltage 160. Graph 506 represents DC input voltage signal 130 or a positive half-cycle of AC input voltage signal 108. Graph 508 represents the inductor current through inductor 306, and graph 510 represents the average inductor current, which also equals to the AC input current signal 110 (Iᵢₙ). Graph 512 represents the variation of V_{M} signal for main switch 308, and graph 514 represents the variation of V_{SR} signal for SR switch 310.

In FIG. 5, in each switching cycle, controller 312 can determine the duration of main switch turn-on interval (t_{M}) based on a target positive peak current I_{p,peak}, which in turn can set the average input current over the switching cycle. To reduce the phase difference between AC input current signal 110 and the AC input voltage signal 108, controller 312 can determine t_{M} such that the average input current of each switching cycle has a constant relationship with the AC input voltage signal of the respective switching cycle. Referring again to Equation 3, as the DC input voltage signal 130 (which reflects AC input voltage signal 108) is proportional to the positive peak current in a switching cycle, controller 312 can maintain t_{M} at a substantially constant value based on a target current to be supplied to load 106 and capacitor 118. Controller 312 can also adjust the duration of SR switch turn-on interval (t_{SR}) between different switching cycles to provide time for the inductor current to drop from the positive peak value to zero, and to adjust the step-up ratio between DC output voltage signal 112 (Vₒᵤₜ) and DC input voltage signal 130 (V_{in,dc}), as the DC input voltage and the positive peak inductor current vary with the AC input voltage. Accordingly, the switching cycles can have a varying frequency. The switching cycle periods can be at a maximum when DC input voltage signal 130 becomes closer to reference DC output voltage 160, and controller 312 can increase t_{SR} to reduce the step-up ratio. Also, the switching frequency can be at a maximum as DC input voltage signal 130 approaches zero, and controller 312 can decrease t_{SR} to increase the step-up ratio. For example, in FIG. 5, the third cycle period comprising t_{M}(3) and t_{SR}(3) and the fourth cycle period comprising t_{M}(4) and t_{SR}(4) can have the maximum durations within the half-cycle, and the zeroth cycle period comprising t_{M}(0) and t_{SR}(0) and the seventh cycle period comprising t_{M}(7) and t_{SR}(7) can have the minimum durations within the half-cycle.

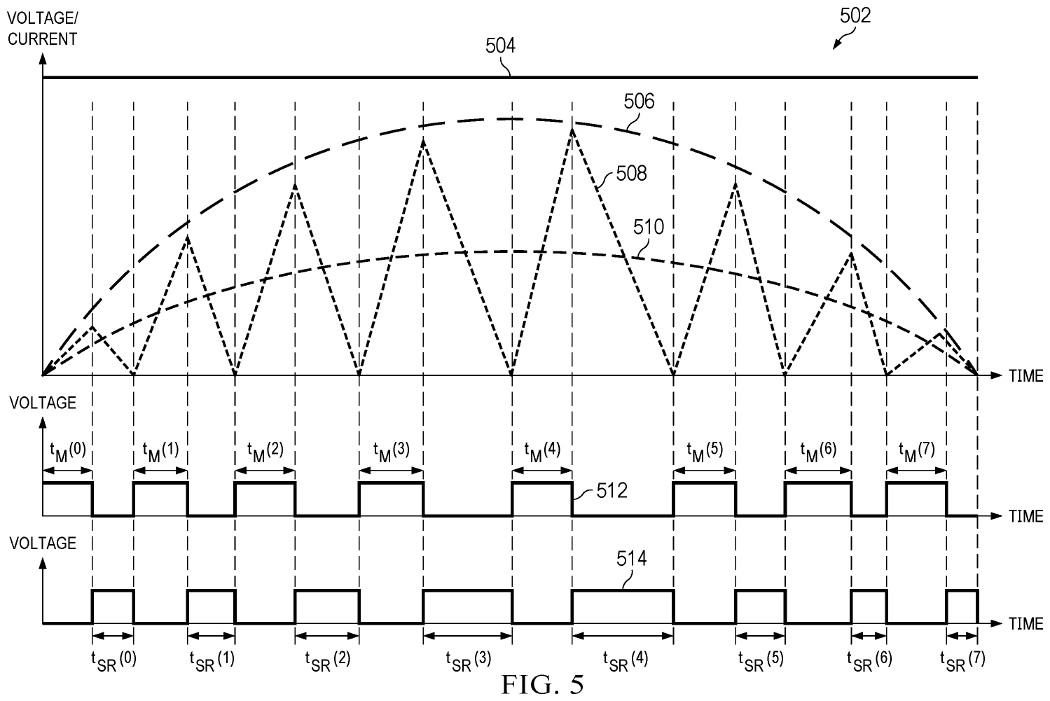

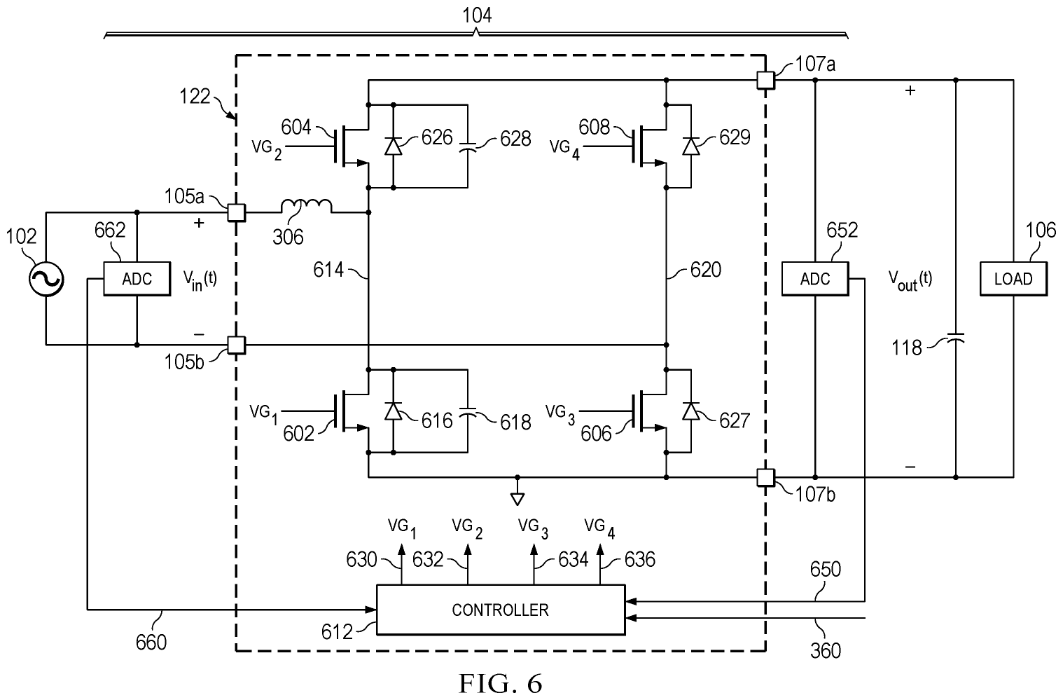

FIG. 6 is a schematic diagram of another example of power supply system 104, in which the operations of rectifier circuit 120 and power converter circuit 122 are performed using a set of switches and their body diodes. Referring to FIG. 6, power supply system 104 can include power converter circuit 122, which includes inductor 306 and switches 602, 604, 606, and 608, and a controller 612 coupled to power converter circuit 122. Switches 602, 604, and inductor 306 are coupled at a node 614, and switches 602 and 604 are coupled in series between positive output 107a and negative output 107b. Node 614 can switch between the positive and negative power supply rails and can be a switching node. Also, switches 606 and 608 are coupled at a node 620, and switches 606 and 608 are also coupled in series between positive output 107a and negative output 107b. Inductor 306 is coupled between positive input 105a and node 614, and node 620 between switches 606 and 608 is coupled to negative input 105b.

Switches 602, 604, 606 and 608 can be NFETs. Switches 602 and 604 can support multiple switching cycles within a half cycle of AC input voltage signal 108 (Vᵢₙ), and switches 606 and 608 can switch once every half cycle of the AC input voltage signal. Each of switches 602 and 604 can have a higher bandwidth than the respective switches 606 and 608. In some examples, each of switches 602 and 604 can include a transistor such as an NFET or a GaN HEMT, and each of switches 606 and 608 can include a FET. Switch 602 can have a body diode 616 and a parasitic capacitor 618, and switch 604 can have a body diode 626 and a parasitic capacitor 628. Switch 606 can have a body diode 627, and switch 608 can have a body diode 629. For simplicity, the parasitic capacitances of switches 606 and 608 are omitted.

In some examples, switches 602, 604, 606, and 608, and inductor 306 can be configured as a totem pole boost rectifier. Controller 612 can generate control signals 630 (labelled VG₁), 632 (labelled (VG₂), 634 (labelled VG₃), and 636 (labelled VG₄) to enable/disable, respectively, switches 602, 604, 606, and 608 to perform rectification, power factor correction, and step-up conversion operations.

During a positive half-cycle of Vᵢₙ when negative input 105b receives a lower voltage than positive input 105a, switch 606 is enabled to couple the negative power supply rail (and negative output 107b) to negative input 105b to receive the lower input voltage, while inductor 306 (when switch 604 is enabled) can connect the positive power supply rail (and positive output 107a) to positive input 105a. Accordingly, positive output 107a can have a positive polarity and negative output 107b can have a negative polarity. Also, switch 608 is disabled to cause the inductor current to flow through capacitor 118 and load 106 and return to AC power source 102 via switch 606. Controller 612 can operate switch 602 as the main switch and switch 604 as the SR switch. Controller 612 can generate a sequence of control signals VG₁ identical to control signals V_{M} and a sequence of control signals VG₂ identical to control signals V_{SR} in FIG. 4. In each switching cycle of the positive half-cycle of Vᵢₙ, in the charging interval (t_{M}), switch 602 is enabled and switch 604 is disabled. The charging interval also includes a first charging interval in which the inductor is charged. The charging interval is followed by a first dead time interval (t_{dt1})in which both switches are disabled. The first dead time interval can include a first resonant interval tᵣₑₛ₁, in which the voltage of node 614 transitions to the positive power supply rail (e.g., Vₒᵤₜ) by resonance. The first dead time interval is followed by the discharging interval (t_{SR}) in which the switch 602 is disabled and switch 604 is enabled, and the inductor discharges. The discharging interval is followed by the second dead time interval (t_{dt2}), which can include a second resonant interval tᵣₑₛ₂ in which the voltage of node 614 transitions to negative power supply rail (e.g., ground) by resonance, and a second charging interval in which the inductor is charged. A new switching cycle can start after the second dead time interval. ZVS can be achieved if the voltage of node 614 completes transition to ground by the end of the second resonant interval, so that the voltage across switch 602 is zero (or below zero) when switch 602 changes from the disabled state to the enabled state to start the new switching cycle.

During a negative half-cycle of Vᵢₙ when negative input 105b receives a higher voltage than positive input 105a, switch 608 is enabled to couple the positive power supply rail (and positive output 107a) to negative input 105b to receive the higher input voltage, while the negative power supply rail (and negative output 107b) is coupled to positive input 105a, to maintain the same polarities between the positive power supply rail and the negative power supply rail across the positive and negative half-cycles. Also, switch 606 is disabled to allow the inductor current to flow through capacitor 118 and load 106 and return to AC power source 102 via switch 602. Controller 612 can operate switch 604 as the main switch and switch 602 as the SR switch. Controller 612 can generate a sequence of control signals VG₂ identical to control signals V_{M} and a sequence of control signals VG₁ identical to control signals V_{SR} in FIG. 4. In each switching cycle of the negative half-cycle of Vᵢₙ, in the charging interval (t_{M}), switch 602 is enabled and switch 604 is disabled, and the inductor is charged. The charging interval is followed by the first dead time interval (t_{dt1}) in which both switches are disabled, and the voltage of node 614 transitions to the negative power supply rail (e.g., ground) by resonance. The first dead time interval is followed by the discharging interval (t_{SR}) in which the switch 602 is disabled and switch 604 is enabled, and the inductor discharges. The discharging interval is followed by the second dead time interval (t_{dt2}), in which the voltage of node 614 transitions to the positive power supply rail (e.g., Vₒᵤₜ) by resonance, followed by charging of the inductor, and a new switching cycle can start after the second dead time interval. ZVS can be achieved if the voltage of node 614 completes transition to Vₒᵤₜ by the end of the second interval, so that the voltage across switch 602 is zero (or below zero) when switch 602 changes from the disabled state to the enabled state to start the new switching cycle.

Controller 612 can receive measurements 650 of the magnitude of DC output voltage signal 112 (Vₒᵤₜ) from a measurement circuit 652 (e.g., and ADC), measurements 660 of the polarity and magnitude of AC input voltage signal 108 (Vᵢₙ) from a measurement circuit 662 (e.g., an ADC), and reference DC output voltage 360. Controller 612 can determine whether AC input voltage signal 108 is in the positive half-cycle or in the negative half-cycle based on measurements 660. Controller 612 can also determine t_{M} for switch 602 and t_{SR} for switch 604 based on measurements 650 and reference DC output voltage 360 in both half-cycles.

In some examples, to operate the example power converters of FIG. 3 and FIG. 6 in CRM, the controller (such as controllers 312 and 612) may measure the inductor current through inductor 306 as the inductor current drops during the turn-on interval of the SR switch, and disable the SR switch when the inductor current crosses zero or reaches the minimum SR turn-off current sufficient for the voltage across the main switch to complete transition to one of the power supply rails in the second resonant period to achieve zero voltage switching (ZVS). The controller may extend the turn-on interval of the SR switch (t_{SR}) if the magnitude of the AC input voltage exceeds half of the DC output voltage, as described above. Moreover, the controller may determine the duration of the second dead time interval (t_{dt2}) based on the SR turn-off current. Specifically, the controller may detect the inductor current within a switching cycle, determine the turn-on interval of the SR switch (t_{SR}), and adjust the timing of control signals of the main switch and the SR switch within the same switching cycle.

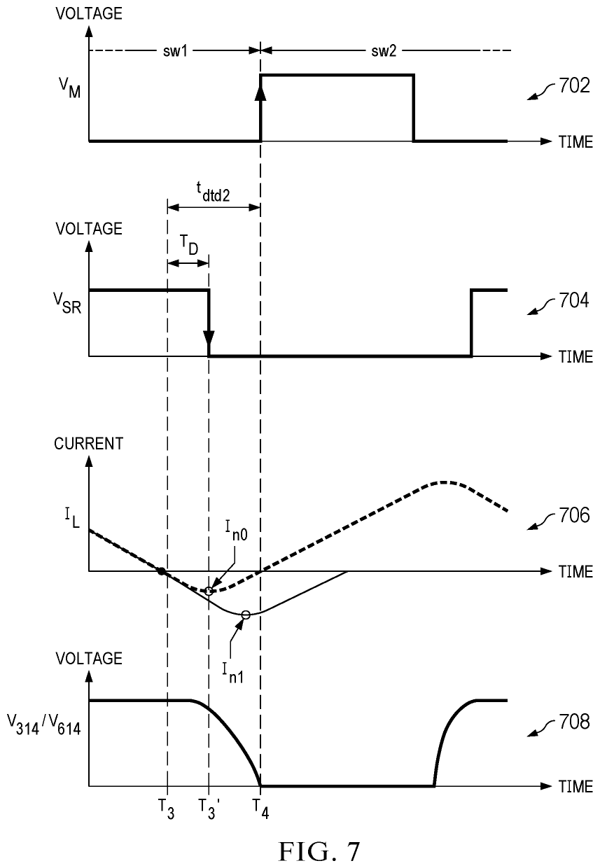

FIG. 7 includes graphs 702, 704, 706, and 708 that illustrate example operations of power converter circuit 122 between two switching cycles and the effect of delay in the adjustment of V_{SR} control signal. Graph 702 illustrates the variation of V_{M} control signal with respect to time, and graph 704 illustrates the variation of V_{SR} control signal with respect to time. Also, graph 706 illustrates the variation of inductor current with respect to time, and graph 708 illustrates the variation of voltage of node 314/614 with respect to time. The time notations are based on FIG. 4.

As shown in FIG. 7, towards the end of first switching cycle sw1, at time T₃ the inductor current crosses zero. The controller can disable the SR switch at time T₃ to provide an SR turn-off current sufficient to cause node 314/614 to complete transition to one of the power supply rails. If the SR switch is disabled at time T₃, the negative inductor current can peak at Iₙ₀. But because of a delay To, the SR switch is disabled at time T₃′. As a result, the inductor current becomes more negative after time T₃, and reaches a peak of Iₙ₁.

Various sources can contribute to and increase the delay T_{D}. For example, circuits involved in the inductor current measurement, such as current sensor and an ADC, have limited bandwidth and can incur delay in providing the current measurement data to the controller. The controller can also incur delay in computing the amount of a target SR turn-off current of the switching cycle based on the AC input voltage and the DC output voltage, and determining whether to disable the SR switch by comparing the target SR turn-off current with the inductor current indicated by the current measurement data. Further, the controller may include circuits, such as a pulse width modulator (PWM) circuit and a driver circuit, to generate and transmit the control signals to the main switch and the SR switch. Those circuits can also incur additional delay in generating the control signals.

The additional negative peak inductor current can increase current ripple, which can incur additional power loss and increase distortions in the AC input current. Specifically, the average current of each switching cycle is based on the negative peak current and the positive peak current I_{p,peak} of the switching cycle. If the negative peak current becomes more negative compared with a target negative peak current of the switching cycle, the average AC input current across the switching cycles may no longer follow the AC input voltage, which can lead to substantial distortion.

To reduce the distortion, the controller may increase the positive peak current of that switching cycle (e.g., by increasing the turn-on interval of the main switch, t_{M}, to match the negative peak current. Such arrangements can maintain the shape of the average inductor current across switching cycles, and the average inductor current can have a constant relationship with the AC input voltage. But increasing the positive peak current in each switching cycle can lead to additional power drawn from the AC power source, and much of the additional power is lost due to the negative inductor current that does not flow to the load. This can increase the power loss in power supply system 104 and reduce the efficiency of the power transfer from AC power source 102 to load 106.

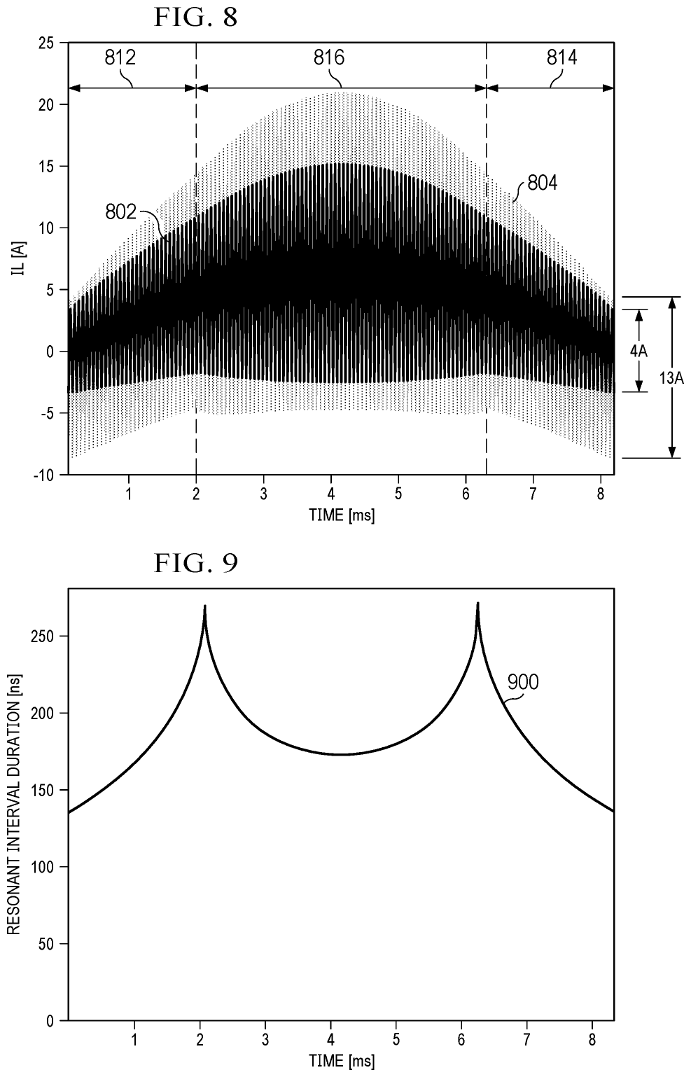

FIG. 8 illustrates graphs 802 and 804 of example variation of inductor current of power supply system 104 with respect to time. Graph 802 illustrates the variation of inductor current without the delay T_{D} within a half-cycle of the AC input voltage, and graph 804 illustrates the variation of inductor current with a delay T_{D} of about 100 nanoseconds (ns) within the same half-cycle. Referring to FIG. 8, within intervals 812 and intervals 814 close to the zero AC input voltage, the inductor current has larger current ripples in graph 804 than in graph 802. For example, at the beginning and end of the half-cycle, the maximum current ripple is at 4 Amperes (A) without the delay, but with the delay the maximum current ripple is at 13A. In the operation of graph 802, there is no delay T_{D}, but the controller can extend the turn-on interval of the SR switch and provide additional negative inductor current to discharge the main switch in the second resonant interval, as described above. In graph 804, the delay To can also extend the turn-on interval of the SR switch (t_{SR}) to provide the additional negative inductor current. Increased current ripples in intervals 812 and 814 can substantially increase the power loss in power supply system 104 and reduce the efficiency of the power transfer from AC power source 102 to load 106.

Also, referring again to FIG. 7, after determining that SR switch is to be disabled at T₃, the controller may determine the duration of the second dead time interval (t_{dt2}) to provide time for the voltage of node 314/614 to transition to one of the power supply rails, and determine that the main switch is to be enabled to start the next switching cycle (sw2) at time T₄, to achieve ZVS for the main switch, while reducing the interval in which the body diode of the main switch conducts the inductor current as in FIG. 4. The controller can determine the second resonant interval tᵣₑₛ₂ based on the SR turn-off current (the inductor current when the SR switch is disabled), the input voltage (Vᵢₙ of FIG. 6 or V_{in,dc} of FIG. 3), the output voltage Vₒᵤₜ, as well as the resonant frequency of inductor 306 with the parasitic capacitance of the main switch and the SR switch at the switching node, as described above, and dynamically changes the duration of the second dead time interval t_{dt2} to match or accommodate the second resonant interval tᵣₑₛ₂ between different switching cycles.

FIG. 9 illustrates a graph 900 of example variations of the durations of the second resonant interval tᵣₑₛ₂ with respect to time within a half-cycle of the AC input voltage. In the operation represented in FIG. 9, a minimum amount of SR turn-off current that allows the switching node (e.g., nodes 314/614) to transition to one of the power supply rails is provided in each switching cycle. Also, the minimum second resonant interval is provided in each switching cycle for the switching node to complete the transition, and the duration of the second resonant interval varies according to the SR turn-off current. The second dead time interval duration (t_{dt2}) is also adjusted to match the second resonant interval in each switching cycle. In the example of FIG. 9, tᵣₑₛ₂ can be at the minimum at the beginning and end of the half-cycle. Between 0 to about 2 milliseconds (ms), the controller can set the turn-on interval of the SR switch (t_{SR}) to have zero SR turn-off current, and tᵣₑₛ₂ can increase with the AC input voltage and peaks at about 0.28 ms. Between 2 ms to 4.1 ms, the controller can extend the turn-on interval of the SR switch to increase the negative SR turn-off current, and tᵣₑₛ₂ can decrease. The extension of the turn-on interval of the SR switch increases with the AC input voltage and is at the maximum at 4.1 ms. Between 4.1 ms and 6.5 ms, the extension of the turn-on interval of the SR switch reduces with the AC input voltage, which reduces the negative SR turn-off current and increases tᵣₑₛ₂. Between 6.5 ms and 8.2 ms (end of the half-cycle), the controller can set the turn-on interval of the SR switch t_{SR} such that there is zero SR turn-off current, and tᵣₑₛ₂ can reduce with the AC input voltage.

The operations represented in graph 900, where the controller adjusts the duration of the second dead time interval t_{dt2} in each switching cycle based on the minimum SR turn-off current to match the varying second resonant interval, can use lots of power in sensing, processing, and computation, yet are also error prone, which can reduce the efficiency of the power converter. Specifically, in order to adjust the duration of the second resonant interval in each switching cycle, the controller may receive measurements of the SR turn-off current from a current sensor in each switching cycle and perform computations to determine the resonant time based on the SR turn-off current, and the dead time to accommodate the resonant time. But this may require the current sensor to have a high bandwidth and a high accuracy, and such a current sensor can consume lots of power. Moreover, computing the duration of the second dead time interval can be computation intensive, and performing such computations in each switching cycle can also lead to substantial power consumption by the controller.

Also, adjusting the duration of the second dead time interval based on SR turn-off current can be error prone. Specifically, the controller may determine the durations of on-time of the SR switch t_{SR}, as well as the durations of the second dead time interval t_{dt2} (and the second resonant interval), based on measuring the SR turn-off current, which can be represented by the inductor current when the SR switch is disabled. However, as described above, the circuits involved in the inductor current detection, such as current sensor and ADC, have limited bandwidth and can incur delay in providing the current measurement data to the controller. Because of the delay, the current measurement data used by the controller to determine t_{dt2} may not reflect the actual inductor current when the SR switch is disabled, which can introduce errors in the determination of t_{SR} and t_{dt2}. If t_{dt2} is too short, the controller may enable the main switch prior to the voltage of node 314/614 transitioning to one of the power supply rails, which leads to non-ZVS and can incur additional power loss in the switching of the main switch. Also, if t_{dt2} is too long, the controller may enable the main switch long after the voltage of node 314/614 transitions to one of the power supply rails. This can cause the inductor current to flow through the body diode of the main switch (e.g., diode 316 of FIG. 3, body diode 616 of FIG. 6 in the positive half cycle, body diode 626 of FIG. 6 in the negative half cycle), as between T₄ and T₅ of FIG. 4. As the body diode has a larger resistance than the enabled main switch, a larger power loss can be incurred which reduces the efficiency of power supply system 104.

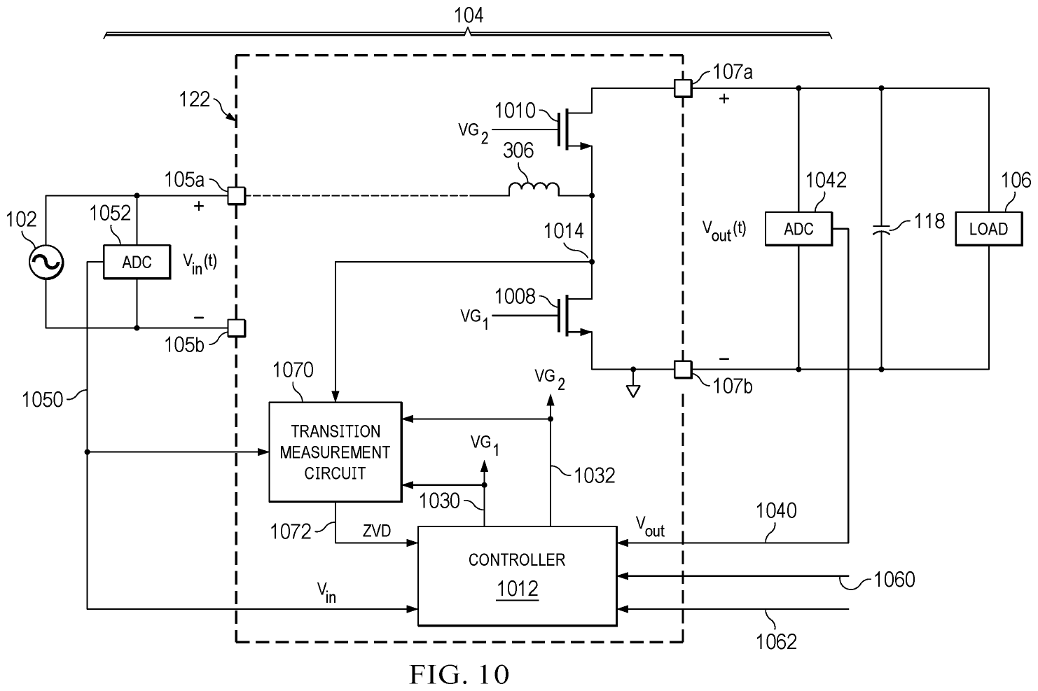

FIG. 10 is a schematic diagram of power converter circuit 122 that can address at least some of the issues described above. Referring to FIG. 10, power converter circuit 122 can include inductor 306, a switch 1008, and a switch 1010, and a controller 1012 coupled to power converter circuit 122. Controller 1012 can control switches 1008 and 1010. Controller 1012 can be part of a microcontroller (MCU), an application specific integrated circuit (ASIC), or a field-programmable gate array (FPGA). Inductor 306 and switches 1008 and 1010 can be coupled at a switching node 1014, and switches 1008 and 1010 can be coupled in series between positive output 107a and negative output 107b. In some examples, switches 1008 and 1010 can be part of boost converter of FIG. 3, where switches 1008 and 1010 correspond to, respectively, main switch 308 and SR switch 310 of FIG. 3, and inductor 306 is coupled to positive input 105a via rectifier circuit 120 (e.g., diode bridge 304). In some examples, switches 1008 and 1010 can also be part of a totem pole boost converter and correspond to, respectively, switch 602 and switch 604 of FIG. 6. Inductor 306 can be coupled directly to positive input 105a. In a positive half-cycle of AC input voltage signal 108, switch 1008 can operate as a main switch and switch 1010 can operate as an SR switch. In a negative half-cycle of AC input voltage signal 108, switch 1008 can operate as an SR switch and switch 1010 can operate as a main switch. In FIG. 10, the body diode, and parasitic capacitances of switches 1008 and 1010 are omitted for simplicity.

Controller 1012 can generate control signal 1030 (labelled V_{G1} in FIG. 10) to enable/disable switch 1008 and control signal 1032 (labelled V_{G2} in FIG. 10) to enable/disable switch 1010 in each switching cycle. The controller 1012 can provide the control signal 1030 at first control output that is coupled to a first power converter control terminal (e.g., a control terminal of the switch 1008). The controller 1012 can provide the control signal 1032 at second control output that is coupled to a second power converter control terminal (e.g., a control terminal of the switch 1010). As in FIG. 4, in a case where controller 1012 operates switch 1008 as a main switch and switch 1010 as an SR switch, controller 1012 can include a first dead time interval (t_{dt1}) between the end of turn-on interval of switch 1008 and the start of turn-on interval of switch 1010 within a switching cycle, and a second dead time interval (t_{dt2}) between the end of the turn-on interval of switch 1010 and the start of turn-on interval of switch 1008 of two adjacent switching cycles. Also, in a case where controller 1012 operates switch 1010 as a main switch and switch 1008 as an SR switch, controller 1012 can include a first dead time interval (t_{dt1}) between the end of turn-on interval of switch 1010 and the start of turn-on interval of switch 1008 within a switching cycle, and a second dead time interval (t_{dt2}) between the end of the turn-on interval of switch 1008 and the start of turn-on interval of switch 1010 of two adjacent switching cycles.

In some examples, to simplify the computations involved in determining the timing of the V_{G1} and V_{G2} control signals, controller 1012 can set the duration of the second dead time interval at a constant value across multiple switching cycles within a cycle of AC input voltage signal 108 (Vᵢₙ), and determine the durations of the first dead time interval (t_{dt1}), the turn-on interval of the main switch (t_{M}) and the turn-on interval of SR switch 1010 (t_{SR}) based on that value. In some examples, controller 1012 can set the duration of the second dead time interval based on a programming value. As controller 1012 needs not compute the duration of the second dead time interval for each switching cycle, the computations involved in determining the timing of the V_{G1} and V_{G2} control signals can be substantially reduced. Controller 1012 can adjust the turn-on interval of the SR switch (t_{SR}) to adjust the SR turn-off current such that switching node 1014 can complete transition to a target voltage (e.g., one of the positive/negative power supply rails) within the second dead time interval, so that the enabling of the main switch can be under the ZVS condition. Such arrangements also allow the second resonant interval tᵣₑₛ₂ to be maintained at a constant value across different switching cycles within a cycle of the AC input voltage signal. In a case where switch 1010 operates as an SR switch, controller 1012 can adjust the turn-on interval of switch 1010 to enable switching node 1014 to complete transition to the negative power supply rail at the end of the second dead time interval, prior to switch 1008 (operating as the main switch) being enabled. In a case where switch 1008 operates an SR switch, controller 1012 can adjust the turn-on interval of switch 1008 to enable switching node 1014 to complete transition to the positive power supply rail at the end of the second dead time interval, prior to switch 1010 (operating as the main switch) being enabled.

Controller 1012 can receive measurements 1040 of DC output voltage signal 112 (Vₒᵤₜ(t)) from a measurement circuit 1042 (e.g., ADC), measurements 1050 of AC input voltage signal 108 (Vᵢₙ(t)) from a measurement circuit 1052 (e.g., an ADC), and a reference DC output voltage 1060. In some examples, controller 1012 can also receive programming data 1062 for use in determining the turn-on interval of switch 1008, the turn-on interval of switch 1010, the first dead time interval, and/or the second dead time interval. The programming data 1062 can include, for example, a value representing a resonant time constant (τ=\sqrt{LC}) of a resonant circuit comprising inductor 306 and a capacitor representing, for example, total parasitic capacitances of switches 1008 and 1010 at switching node 1014 coupled to the inductor 306, where L can represent the inductance of inductor 306 and C can represent the capacitance. In some examples, the programming data 1062 can include a value representing a resonant impedance

$$( \sqrt{\frac{L}{C}} )$$

of the resonant circuit formed by the Controller 1012 can control the charging interval/turn-on interval of the main switch (t_{M}) and the discharging interval/turn-on interval of SR switch 1010 (t_{SR}) based on the measurements, the reference, and the programming data to achieve a target DC output voltage signal 112. Also, controller 1012 can determine the duration of control signals V_{G1} and V_{G2} based on measurements of AC input voltage signal 108 to maintain a constant relationship between AC input current signal 110 and AC input voltage signal 108, as described above.

Also, power converter circuit 122 can include a transition measurement circuit 1070 to determine a status of transition of switching node 1014 when the main switch (one of switches 1008 or 1010) changes state at the beginning of a switching cycle. Transition measurement circuit 1070 can be coupled to switching node 1014 and can receive at least one of control signal 1030 (V_{G1}) or control signal 1032 (V_{G2}) from controller 1012. Based on the voltage of switching node 1014, transition measurement circuit 1070 can determine, at the beginning of a switching cycle, whether switching node 1014 transitions to a target voltage (e.g., one of the positive or negative power supply rails) to achieve zero voltage switching (ZVS) of the power converter main switch. Also, based on one of the control signals 1030 or 1032, transition measurement circuit 1070 can generate an indication signal 1072 indicating whether switching node 1014 completes the transition prior to when controller 1012 enables the main switch. In some examples, transition measurement circuit 1070 can include a comparator to compare the voltage of switching node 1014 against a threshold based on the target voltage, and digital logic circuits to generate indication signal 1072 based on the output of the comparator and a timing of the control signal from controller 1012 targeted at the main switch (one of V_{G1} or V_{G2}).

In a case where switches 1008 and 1010 are part of a boost converter where switch 1008 is a main switch and switch 1010 is an SR switch, transition measurement circuit 1070 can generate indication signal 1072 based on whether switching node 1014 transitions to the negative power supply rail prior to main switch 1008 being enabled by control signal V_{G1}. Also, in a case where switches 1008 and 1010 are part of a totem pole boost converter, transition measurement circuit 1070 can also receive measurements 1050 of AC input voltage signal 108. If power supply system 104 is in the positive half-cycle of the AC input voltage where switch 1008 operates as a main switch and switch 1010 operates as an SR switch, transition measurement circuit 1070 can generate indication signal 1072 based on whether switching node 1014 transitions to the negative power supply rail prior to main switch 1008 being enabled by control signal V_{G1}. If power supply system 104 is in the negative half-cycle of the AC input voltage where switch 1008 operates as an SR switch and switch 1010 operates as a main switch, transition measurement circuit 1070 can generate indication signal 1072 based on whether switching node 1014 transitions to the positive power supply rail prior to main switch 1010 being enabled by control signal V_{G2}.

Controller 1012 can adjust the switching cycle period based on indication signal 1072. If indication signal 1072 indicates that switching node 1014 completes the transition prior to main switch 1008 changes from the disabled state to the enabled state, such an indication can reflect that the SR turn-off current is more than sufficient for the switching node to complete the transition within the second dead time interval t_{dt2}. Accordingly, controller 1012 can reduce the duration of the switching cycle period, which can also lead to a reduced duration of t_{SR}, to generate less SR turn-off current, and the SR turn-off current can become less negative when the SR switch is disabled. But if indication signal 1072 indicates that switching node 1014 does not complete the transition prior to controller 1012 enables main switch 1008, such an indication can reflect that the SR turn-off current is insufficient for the switching node to complete the transition within t_{dt2}, and controller 1012 can increase the switching cycle period, which can also lead to an increased duration of t_{SR}, to increase the SR turn-off current, and the SR turn-off current can become more negative when the SR switch is disabled. With such arrangements, controller 1012 can adjust the t_{SR}and SR turn-off current, so that switching node 1014 can complete transition to the target voltage (e.g., ground) within the second dead time interval t_{dt2}, including the case where and t_{dt2} and tᵣₑₛ₂ are fixed across the switching cycles.

In examples of the power supply system 104 described herein, the controller 1012 can determine the durations of the first dead time interval (t_{dt1}), the charging interval (t_{M}), and the discharging interval (t_{SR}), and the timing of the control signal 1030 and the control signal 1032, based on a constant value for the second dead time interval (t_{dt2}) and a system of transcendental equations, in which angles representing the durations of t_{dt1}, t_{dt2}, t_{M}, and t_{SR} with respect to the switching cycle period are variables. based on. In some cases, such equations can be solved using an iterative numerical method, but the iterative numerical method can be computation intensive and may be unsuitable for real-time implementation. Also, the phase angles determined from the iterative numerical method may or may not represent an exact analytical solution to the equations, which can degrade the accuracy of determining the durations of t_{dt1}, t_{dt2}, t_{M}, and t_{SR} to provide switching under ZVS conditions. By presetting one of the variables, t_{dt2}, to a particular value, such equations can be solved with an exact analytical solution, which can reduce the complexity of computation of the durations of t_{dt1}, t_{dt2}, t_{M}, and t_{SR} and speed up the computation. Also, because t_{dt1}, t_{dt2}, t_{M}, and t_{SR} are computed as part of exact analytical solutions, the computed values reflect the actual durations of t_{dt1}, t_{dt2}, t_{M}, and t_{SR} to achieve ZVS. In some examples, the controller 1012 can set the angle of the second dead time interval, which can represent the valley resonant transition interval, to 90°, allowing use of a mathematical identity to simplify the equations and computation of an analytical solution. Interval values are calculated and used to generate the control signal 1030 and the control signal 1032.

The controller 1012 does not rely on high bandwidth current sensors, thereby decreasing circuit complexity and cost. Accurate dead time control reduces hard switching and improves switching transistor performance. Also, because t_{dt1}, t_{dt2}, t_{M}, and t_{SR} can be updated quickly due to the reduced complexity of computation, the delay in adjusting t_{dt1}, t_{dt2}, t_{M}, and t_{SR} can be reduced, which can reduce current ripples and distortions (e.g., total harmonic distortion (THD)).

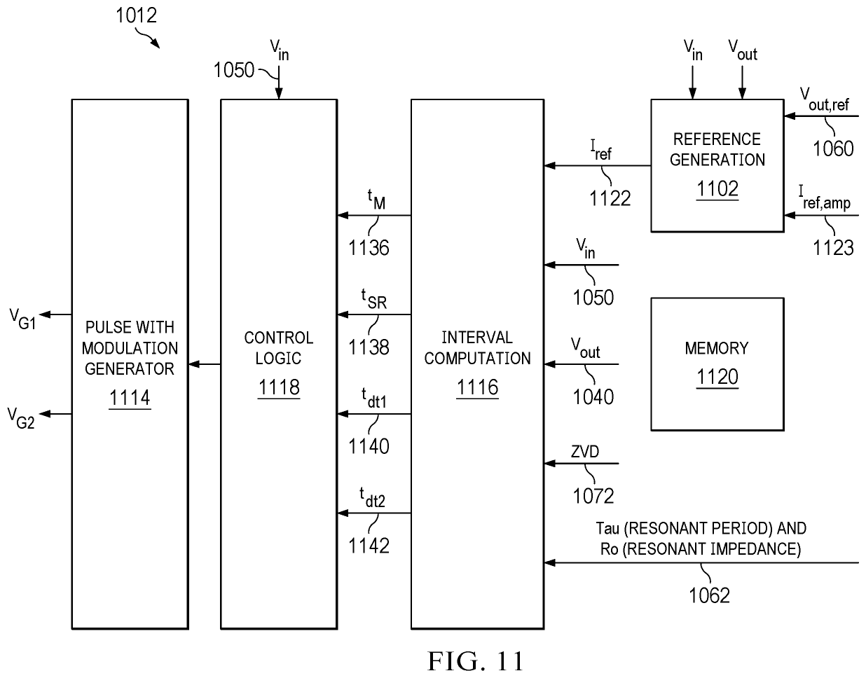

FIG. 11 is a block diagram of example internal components of controller 1012. As shown in FIG. 11, controller 1012 can include a reference generation circuit 1102, an interval computation circuit 1116, and a pulse width modulation (PWM) generator circuit 1114. Controller 1012 further includes a control logic circuit 1118 to control the operations of these components, and a memory 1120 to support the operations. As described above, controller 1012 can be part of a microcontroller (MCU), an application specific integrated circuit (ASIC), or a programmable logic circuit such as a field-programmable gate array (FPGA). Memory 1220 can include volatile and/or non-volatile memory, such as static random-access memory (SRAM), dynamic random-access memory (DRAM), flash memory, erasable programmable read-only memory (EPROM). In a case where controller 1012 is an MCU, each of circuits 1102-1118 can be implemented by instructions executable by the MCU, and memory 1120 can store the instructions executable by the MCU. In a case where controller 1012 is an ASIC or a FPGA, each of circuits 1102-1118 can be implemented by dedicated circuitry including logic circuits. Memory 1220 can also provide storage for the input data and output data for each of circuit.

Reference generation circuit 1102 can generate a digital value 1122 representing the magnitude of a reference current I_{ref}. The reference current can represent a target of the AC input current signal 110 (Iᵢₙ(t)) and can be a sinusoidal current signal having the same frequency and phase as AC input voltage signal 108 (Vᵢₙ), to maintain a power factor equal to or substantially close to one. The reference current information can also be provided by an outer control loop to control power supply system 104 to provide a DC output voltage that matches the reference DC output voltage.

Reference generation circuit 1102 can generate I_{ref} in various ways. In some examples, reference generation circuit 1102 can receive, from the output control loop, a digital value 1123 representing the peak value or the amplitude of reference current, I_{ref,amp}. Reference generation circuit 1102 can also receive measurements 1050, determine a normalized Vᵢₙ (e.g., having an amplitude of 1V) from measurements 1050, and generate digital value 1122 of I_{ref} by multiplying I_{ref,amp} with the normalized Vᵢₙ. In some examples, reference generation circuit 1102 can also receive measurements 1040 representing DC output voltage signal 112 (Vₒᵤₜ) and reference DC output voltage 1060 (V_{out,ref}). Reference generation circuit 1102 can include a subtraction circuit to generate a difference between DC output voltage signal 112 and reference DC output voltage 1060, and a proportional integration (PI) controller to generate I_{ref,amp} internally based on the difference. Reference generation circuit 1102 can then generate digital value 1122 of I_{ref} by multiplying I_{ref,amp} with the normalized Vᵢₙ from measurements 1050.

Interval computation circuit 1116 can generate digital value 1136 (t_{M}) representing a charging interval, digital value 1138 (t_{SR}) representing a discharging interval, digital value 1140 (t_{dt1}) representing a first dead time interval, and digital value 1142 (t_{dt2}) representing a second dead time interval as illustrated in FIG. 4. The interval computation circuit 1116 can receive the digital value 1122, the measurements 1050, the measurements 1040, the indication signal 1072, and the programming data 1062, and generate the digital values 1136-1142 based on the digital value 1122, the measurements 1050, the measurements 1040, the indication signal 1072, and the programming data 1062. The interval computation circuit 1116 provides the digital values 1136-1142 to the control logic circuit 1118. The control logic circuit 1118 can control the PWM generator circuit 1114 to generate the control signals V_{G1} or V_{G2} at a PWM output based on the digital values 1136-1142.

PWM generator circuit 1114 can generate digital values (e.g., logical one for the first state, a logical zero for the second state) representing control signals V_{G1} and V_{G2}. PWM generator circuit 1114 can then transmit the digital values to a driver circuit (not shown in FIG. 11) to convert the digital values to analog voltage signals to drive switches 1008 and 1010. Control logic circuit 1118 can control PWM generator circuit 1114 to generate a sequence of control signals V_{G1} and V_{G2} with the timing defined by t_{SR}, t_{M}, t_{dt1}, and t_{dt2}.

In some examples, control logic circuit 1118 can include a state machine to control PWM generator circuit 1114 to generate control signals V_{G1} and V_{G2}, and to control the read and write operations to memory 1120. The state machine can operate based on a counter and comparing the count values with digital values 1136, 1138, 1140, and 1142 representing, respectively, t_{SR}, t_{M}, t_{dt1}, and t_{dt2}. Control logic circuit 1118 can also receive measurements 1050 representing AC input voltage signal 108, determine whether the system operates in the positive half-cycle or in the negative half-cycle of the AC input voltage, and generate control signals V_{G1} and V_{G2} accordingly.

FIG. 12A includes waveform diagrams that illustrate current and voltage in the power supply system of FIG. 10. The time domain graph 1202 illustrates current flow in the inductor 306 over a charge/discharge cycle. The time domain graph 1204 illustrates the voltage across the switch 1008 over the charge/discharge cycle. The time domain graphs 1202 and 1204 are similar to the graphs 406 and 408 shown in FIG. 4. In interval t₁, the switch 1008 is closed and the switch 1010 is open, and the current flowing through the inductor 306 increases to charge the inductor 306. In the interval t₂, the switch 1008 and the switch 1010 are open. In the interval t₃, the switch 1010 is closed and the switch 1008 is open as the inductor 306 is discharged. In the interval t₄, the switch 1008 and the switch 1010 are open. Interval ti can represent the charging interval t_{M}, interval t₂ can represent the first dead time interval t_{dt1}, interval t₃ can represent the discharging interval t_{SR}, and interval t₄ can represent the second dead time interval t_{M}.

FIG. 12B is an example state plane diagram that represents the relationship of voltage and current in the time domain graphs 1202 and 1204. The state plane diagram maps the time domain graphs 1202 and 1204 to i_{L}(v), which represents the dependence of the time domain waveforms. The state dependence is normalized, i_{L}(v)→j_{L}(m). The normalization is expressed as:

$${V}_{base} = {V}_{OUT} \qquad ( Equation 7 )$$

$${I}_{base} = \frac{{V}_{base}}{{R}_{0}} \qquad ( Equation 8 )$$

$${R}_{0} = \sqrt{\frac{L}{C}} \qquad ( Equation 9 )$$

$${ω}_{0} = \frac{1}{\sqrt{LC}} \qquad ( Equation 10 )$$

$$M = \frac{{v}_{IN}}{{V}_{OUT}} \qquad ( Equation 11 )$$

$${j}_{L} = \frac{{i}_{L}}{{I}_{base}} \qquad ( Equation 12 )$$

$$Θ = t ω \qquad ( Equation 13 )$$

$$F = \frac{2 π {f}_{sw}}{{ω}_{0}} \qquad ( Equation 14 )$$

where:
V_{OUT} is output voltage of the power supply system 104.
V_{BASE} is the base voltage selected for normalization.
L is the inductance of the inductor 306.
C is the capacitance at the switch node 1014.
R₀ is the resonant impedance of the resonant circuit including L and C.
I_{BASE} is the base current selected for normalization.
V_{IN} is the input voltage of the power supply system 104.
i_{L} is current flowing in the inductor 306.
ω₀ is the angular resonant frequency of the resonant circuit including L and C.
M is normalized input voltage (normalized with respect to output voltage V_{OUT}).
jL is normalized current.
θ is an angle corresponding to a time interval of the time domain graphs 1202 and 1204.
fsw is switching frequency determined, e.g., in the interval computation circuit 1116.
F is normalized frequency,

$$F = \frac{{f}_{sw}}{{f}_{0}} where {f}_{0} = \frac{1}{2 π \sqrt{LC}} .$$

The following system of equations can be derived from the normalized state plane diagram of FIG. 12B.

$${Θ}_{1} = \frac{{J}_{L 1} + {J}_{L 4}}{M} \qquad ( Equation 15 )$$

$${Θ}_{2} = {tan}^{- 1} ( \frac{M}{{J}_{L 1}} ) + {tan}^{- 1} ( \frac{1 - M}{{J}_{L 2}} ) \qquad ( Equation 16 )$$

$${Θ}_{3} = \frac{{J}_{L 2} + {J}_{L 3}}{( 1 - M )} \qquad ( Equation 17 )$$

$${Θ}_{4} = {tan}^{- 1} ( \frac{1 - M}{{J}_{L 3}} ) + {tan}^{- 1} ( \frac{M}{{J}_{L 4}} ) \qquad ( Equation 18 )$$

$$\frac{2 π}{F} = {Θ}_{1} + {Θ}_{2} + {Θ}_{3} + {Θ}_{4} \qquad ( Equation 19 )$$

$${J}_{L 1}^{2} = ( 1 - 2 M ) + {J}_{L 2}^{2} \qquad ( Equation 20 )$$

$${J}_{L 4}^{2} = ( 1 - 2 M ) + {J}_{L 3}^{2} \qquad ( Equation 21 )$$

$${J}_{L} = ( \frac{F}{2 π} ) ( ( \frac{{J}_{L 1} - {J}_{L 4}}{2} ) {Θ}_{1} + ( \frac{{J}_{L 2} - {J}_{L 3}}{2} ) {Θ}_{3} ) \qquad ( Equation 22 )$$

Equations 15-22 include 11 variables: J_{L1}, J_{L2}, J_{L3}, J_{L4}, θ₁, θ₂, θ₃, θ₄, M, F, and J_{L}. θ₁ is an angle representing the interval t₁ (charging interval) in FIG. 12A, θ₂ is an angle representing the interval t₂ (first dead time interval) in FIG. 12A, θ₃ is an angle representing the interval t₃ (discharging interval) in FIG. 12A, and θ₄ is an angle representing the interval t₄ (the second dead time interval, or valley resonant transition interval) in FIG. 12A and the switching cycle period. The system of equations can have a unique solution, however, the equations are transcendental. In some examples, the solutions to the equations (including values for J_{L1}, J_{L2}, J_{L3}, J_{L4}, θ₁, θ₂, θ₃, θ₄, M, F, and J_{L}) can be found using an iterative numerical method, but such a method is computation intensive and may not be suitable for real-time implementation. Also, the iterative numerical method may or may not provide the exact analytical solution, which degrades the accuracy in determining the intervals to achieve ZVS.

In some examples, the controller 1012 can determine a solution to the equations 15-22 in real-time based on a set of equations derived from Equations 15-22 with θ₄ set to a particular value, hence θ₄ is not an unknown variable to be solved. In some examples, the controller 1012 can set θ₄ to 90°

$$( or \frac{π}{2} ) .$$

Setting θ₄ to 90° can provide a valley resonant transition interval (second dead time interval t₄ or t_{dt2}) that is one-quarter of the resonant period

$$( \frac{π \sqrt{LC}}{2} ) .$$

$${Θ}_{4} = \frac{π}{2} \qquad ( Equation 23 )$$

With θ₄ set to 90°, the following mathematical identity can be applied to simplify some of Equations 15-22:

$$\frac{π}{2} = {tan}^{- 1} ( x ) + {tan}^{- 1} ( \frac{1}{x} ) \qquad ( Equation 24 )$$

For example, equation 18 can be simplified as shown below in equation 25, and the equations 15-22 can be solved analytically.

$${J}_{L 3} = \frac{M ( 1 - M )}{{J}_{L 4}} \qquad ( Equation 25 )$$

The following equations can be derived from Equations 15-22 based on Equations 23-25.

$${J}_{L 4} = 1 - M \qquad ( Equation 26 )$$

$${J}_{L 3} = M \qquad ( Equation 27 )$$

$${J}_{L 1} = \sqrt{{J}_{L 4}^{2} + ( \frac{4 π}{F} ) M ( 1 - M ) {J}_{L}} \qquad ( Equation 28 )$$

$${J}_{L 2} = \sqrt{{J}_{L 1}^{2} - ( 1 - 2 M )} \qquad ( Equation 29 )$$

$${Θ}_{1} = \frac{{J}_{L 1} + {J}_{L 4}}{M} \qquad ( Equation 30 )$$

$${Θ}_{2} = {tan}^{- 1} ( \frac{M}{{J}_{L 1}} ) + {tan}^{- 1} ( \frac{1 - M}{{J}_{L 2}} ) \qquad ( Equation 31 )$$

$${Θ}_{3} = \frac{{J}_{L 2} + {J}_{L 3}}{( 1 - M )} \qquad ( Equation 32 )$$

$${Θ}_{4} = \frac{π}{2} \qquad ( Equation 33 )$$

$$\frac{2 π}{F} = {Θ}_{1} + {Θ}_{2} + {Θ}_{3} + {Θ}_{4} \qquad ( Equation 34 )$$

The interval computation circuit 1116 can implement equations 26-34, with θ₄ set to 90° or

$$\frac{π}{2} ,$$

to determine an exact analytical solution including the values of θ₁, θ₂, and θ₃, and determine the durations of the charging interval, the first dead time interval, the discharging interval, and the second dead time interval based on the values of θ₁, θ₂, θ₃, θ₄. The negative current peaks J_{L3} and J_{L4} (equations 26 and 27) may depend on the ratio between the input and output voltages. In some examples, the interval computation circuit 1116 can implement a different set of equations derived from Equations 15-22 with θ₄ set to a different value other than 90° or

$$\frac{π}{2} .$$

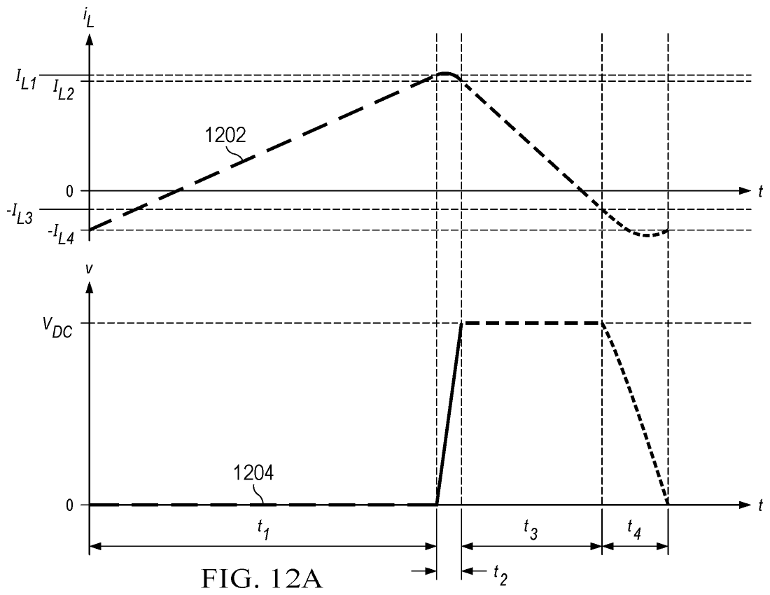

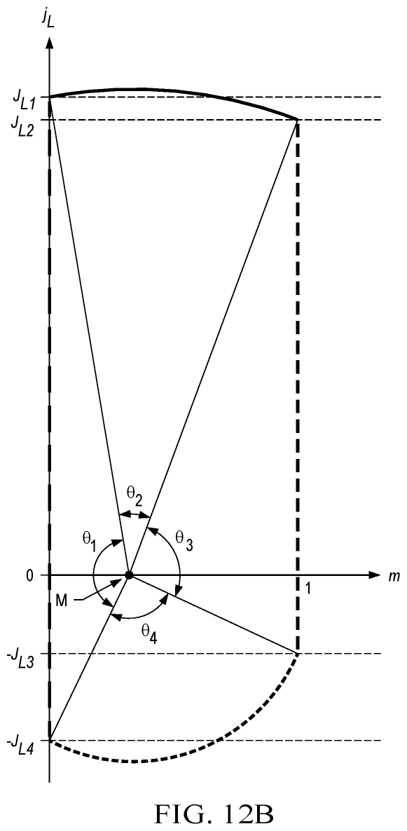

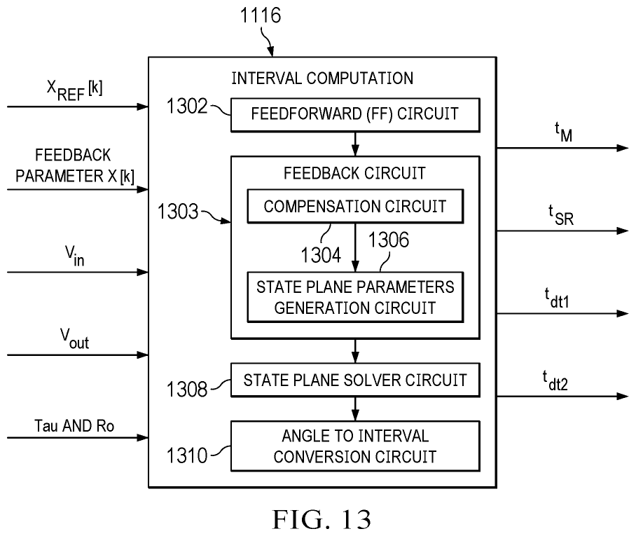

FIG. 13 is a block diagram of an example of a generalized interval computation circuit 1116 configured to solve equations 26-34. The interval computation circuit 1116 includes a feedforward (FF) circuit 1302, a feedback circuit 1303, a state plane solver circuit 1308, and an angle to interval conversion circuit 1310. The feedback circuit 1303 includes a compensation circuit 1304 and a state plane parameters generation circuit 1306.

The interval computation circuit 1116 receives as input digital values x_{REF}[k], x[k], V_{IN}, V_{OUT}, Tau (T), and Ro, and generates from these values three input variable used to solve equations 26-34. The index “k” can represent a particular sampling time or a particular sample of x_{REF} and x. These digital values can represent a state of operation of power supply system 104 in a prior switching cycle, and interval computation circuit 1116 can determine the durations of the durations of the charging interval, the first dead time interval, the discharging interval, and the second dead time interval for a switching cycle subsequent to the prior switching cycle based on these digital values. Specifically, the ratio between output voltage and input voltage

$$( \frac{{v}_{OUT}}{{v}_{IN}} ) ,$$

and a proauct of the ratio between current reference and output voltage and the resonant impedance

$$( e . g . , \frac{{i}_{L , REF} [ k ]}{{v}_{OUT} [ k ]} {R}_{0} ) ,$$

may be used as two of the three variables. The third variable (denoted x[k]) is a measured value used for negative feedback to, for example, adjust the switching cycle period. The third variable can represent a measurement of an operation of power supply system 104 during the first or second dead time period, such as ZVD (zero voltage switching detection), i_{L}, i_{L1}, or i_{L2} as shown in the forthcoming examples.

Also, the interval computation circuit 1116 computes a feedforward value y[k]. The feedforward value can represent an initial target state of operation of power supply system 104, such as a target switching frequency (or switching cycle period), a target peak inductor current during the charging interval (I_{L1}), a target peak inductor current during the discharging interval (I_{L2}), a target average inductor current, a target charging interval duration, a target discharging interval duration, etc. In some examples, the target state can be a target operate state of power supply system 104 to achieve ZVS. The interval computation circuit 1116 can use x[k] as negative feedback to tune the value of y[k], where y[k] is normalized by the interval computation circuit 1116 and used with M and J_{L} (equations 11-12) as inputs to equations 26-34. As shown in forthcoming examples, the value y[k] can be tuned by a compensator.

Various measured values may be used as x[k]. Table 1 below shows examples of x[k] and corresponding examples of x_{REF}[k] used with x[k].

TABLE 1

| x[k] | x_{REF}[k] |
|---|---|
| ZVD[k] | 1 |
| i_{L}[k] | i_{LREF}[k] |
| i_{L1}[k] | i_{L1REF}[k] |
| i_{L2}[k] | i_{L2REF}[k] |

ZVD[k] can be a sample of the of the indication signal 1072 indicating whether zero voltage switching (ZVS) is detected. i_{L}[k] can be a sample of an average current flowing in the inductor 306 (average power converter current). i_{L1}[k] can be a sample of a peak current flowing in the inductor 306 during a charging interval (FIG.12A). i_{L2}[k] can be a peak current flowing in the inductor 306 during a discharging interval (FIG. 12A). The reference signal x_{REF}[k] associated with each x[k] represents a desired/target value of x[k]. For example, i_{LREF}[k] can be a target power converter current, such as target average power converter current (target average inductor current), desired peak charging current, or desired peak discharging current.

Examples of y[k] provided by the interval computation circuit 1116 based on x[k] are shown in Table 2 below. In various examples of the interval computation circuit 1116, y[k] can be any of the variables of the equations 26-34 except x[k].

TABLE 2
y[k]
F[k]
θ₁[k]
θ₃[k]
i_{L}[k]
i_{L1}[k]
i_{L2}[k]

The FF circuit 1302 provides a y_{FF}[k] feedforward value based on the input values. Additional information with regard to the feedforward computation is provided with respect to specific implementations.

y_{FF}[k]=f(v_{IN}[k],v_{OUT}[k],x[k],x_{REF}[k]) (Equation 35)

The FF circuit 1302 provides, at a feedforward output, the feedforward value y_{FF}[k] to a feedforward input of the compensation circuit 1304 for generating y[k]. The compensation circuit 1304 can provide an operation parameter signal y[k] based on y_{FF}[k], and feedback components x[k], and x_{REF}[k] received at a feedback inputs of the compensation circuit 1304. Additional information with regard to the y[k] computation is provided with respect to specific implementations.

y[k]=f(y_{FF}x[k],x[k],x_{REF}[k]) (Equation 36)

The compensation circuit 1304 provides y[k] to the state plane parameters generation circuit 1306. The state plane parameters generation circuit 1306 generates the normalized state plane parameter values (equations 37-39) used to solve the equations 26-34. The state plane parameters generation circuit provides the parameter values, at parameter outputs, to the state plane solver circuit 1308.

$$M [ k ] = \frac{v [ k ]}{{V}_{BASE} [ k ]} \qquad ( Equation 37 )$$

$${J}_{L} [ k ] = \frac{{i}_{L , REF} [ k ]}{{I}_{BASE} [ k ]} \qquad ( Equation 38 )$$

$${y}_{norm} [ k ] = \frac{y [ k ]}{{Y}_{BASE} [ k ]} \qquad ( Equation 39 )$$

where:
v[k] is a measured voltage, such as converter input voltage, converter output voltage, or converter switch node capacitor voltage; and Y_{BASE}[k] is a base associated with the selected y[k]. For example, referring to Table 2, if y[k] is F[k], then Y_{BASE}=f₀; if y[k] is θ₁ or θ₃, then

$${Y}_{BASE} = \frac{1}{{ω}_{0}} ;$$

or it y[k] is i_{L}, i_{L1}, or i_{L2}, then Y_{BASE}=I_{BASE}.

The state plane solver circuit 1308 applies the parameter values (M[k], J_{L}[k], yₙₒᵣₘ[k]) received from the state plane parameters generation circuit 1306, at solver inputs, to solve the equations 26-34. As per equation (33), θ₄ is set to 90°. The state plane solver circuit 1308 provides, at solver outputs, the values of angles θ₁, θ₂, θ₃, and θ₄ to angle inputs of the angle to interval conversion circuit 1310.

The angle to interval conversion circuit 1310 determines the interval values t_{M}, t_{SR}, t_{dt1}, and t_{dt2} (t₁, t₃, t₂, and t₄ of FIG. 12A) for the charging interval, the discharging interval, the first dead time, and the second dead time based on θ₁, θ₃, θ₂, and θ₄ respectively. The angle to interval conversion circuit 1310 can determine the interval time values as:

tⱼ[k]=θⱼ[k]τ[k] j=1 . . . 4 (Equation 40)

where T[k] is the resonant time constant of the power supply system 104, as explained above. The angle to interval conversion circuit 1310 provides, at an interval output, t_{M}, t_{SR}, t_{dt1}, and t_{dt2} to an interval input of the control logic circuit 1118 for generating the control signal 1030 and the control signal 1032.

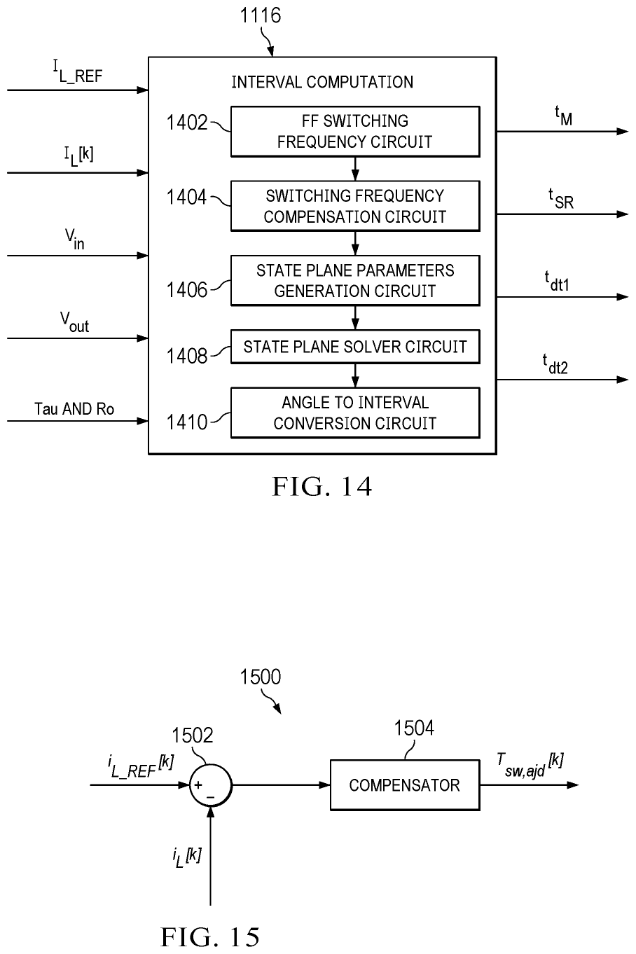

FIG. 14 is a block diagram of an example interval computation circuit 1116 that uses average inductor current (i_{L}[k]) to determine the interval values t_{M}, t_{SR}, t_{dt1}, and t_{dt2}. The interval computation circuit 1116 includes an FF switching frequency circuit 1402 (which can be part of feedforward circuit 1302 of FIG. 13), a switching frequency compensation circuit 1404, a state plane parameter generation circuit 1406, a state plane solver circuit 1408, and an angle to interval conversion circuit 1410. FF switching frequency circuit 1402 can be part of feedforward circuit 1302 of FIG. 13, switching frequency compensation circuit 1404 and state plane parameter generation circuit 1406 can be part of feedback circuit 1303, state plane solver circuit 1408 can be part of state plane solver circuit 1308, and angle to interval conversion circuit 1410 can be part of angle to interval conversion circuit 1310.The interval computation circuit 1116 receives as input digital values I_{L,REF}, I_{L}[k], V_{IN}, V_{OUT}, Tau (T) and Ro.

The FF switching frequency circuit 1402 provides a feedforward (FF) switching frequency value (F_{SW,FF}[k]) based on the input values. The feedforward switching frequency value can represent an initial estimate of the switching frequency value, which can then be adjusted by feedback circuit 1303. In some examples, the FF switching frequency circuit 1402 can provide F_{SW,FF}[k] as follows:

f_{SW,FF}[k]=f(v_{IN}[k],v_{OUT}[k], i_{L,REF}[k]) (Equation 41)

In some examples, the FF switching frequency circuit 1402 may generate F_{SW,FF}[k] based on an approximation that neglects (or otherwise does not account for) resonant transitions:

$${f}_{sw , FF} [ k ] = \frac{{V}_{IN} [ k ] ( 1 - \frac{{v}_{IN} [ k ]}{{v}_{OUT} [ k ]} )}{2 L ( \vert {i}_{L , REF} [ k ] \vert + {I}_{ZVS} )} \qquad ( Equation 42 )$$

where I_{ZVS} can be a constant value representing the negative current used for ZVS where resonant transition of the switching node is absent or otherwise not accounted for.

The FF switching frequency circuit 1402 provides F_{SW,FF}[k] to the switching frequency compensation circuit 1404 for generating f_{sw}[k]. The switching frequency compensation circuit 1404 can provide f_{sw}[k] by combining F_{SW,FF}[k] with a switching cycle period adjustment value, T_{sw.ajd}[k], as follows:

$${f}_{sw} [ k ] = \frac{1}{{T}_{sw , ajd} [ k ]} + {f}_{sw , FF} [ k ] \qquad ( Equation 43 )$$

FIG. 15 is a block diagram of compensation circuitry 1500 of the FF switching frequency circuit 1402 for generation of T_{sw,ajd}[k]. The compensation circuitry 1500 includes a difference circuit 1502 and a compensator circuit 1504. The difference circuit 1502 generates an error signal representing a difference between i_{L}[k] and i_{L,REF}[k], and provides the error signal to the compensator circuit 1504. The compensator circuit 1504 can include a proportional-integral-derivative (PID) controller (or other control process) that modulates T_{sw,ajd}[k] to reduce the difference between i_{L}[k] and i_{L,REF}[k].

Returning to FIG. 14, the switching frequency compensation circuit 1404 provides T_{sw,ajd}[k] to the state plane parameter generation circuit 1406 for use in generation of the state plane parameters. The state plane parameter generation circuit 1406 can generate the normalized state plane parameters as:

$$M [ k ] = \frac{{v}_{IN} [ k ]}{{v}_{OUT} [ k ]} \qquad ( Equation 44 )$$

$${J}_{L} [ k ] = \frac{{i}_{L , REF} [ k ]}{{v}_{OUT} [ k ]} {R}_{0} \qquad ( Equation 45 )$$

$$F [ k ] = \frac{{f}_{sw} [ k ]}{{f}_{0}} \qquad ( Equation 46 )$$

The state plane parameter generation circuit 1406 provides M[k], J_{L}[k], and F[k] to the state plane solver circuit 1408. The state plane solver circuit 1408 applies the parameter values received from the state plane parameter generation circuit 1406 to equations 47-54 to determine θ₁, θ₂, and θ₃.

$${J}_{L 4} [ k ] = 1 - M [ k ] \qquad ( Equation 47 )$$

$${J}_{L 3} = M [ k ] \qquad ( Equation 48 )$$

$${J}_{L 1} [ k ] = \sqrt{{J}_{L 4}^{2} [ k ] + ( \frac{4 π}{F [ k ]} ) M [ k ] ( 1 - M [ k ] ) {J}_{L} [ k ]} \qquad ( Equation 49 )$$

$${Θ}_{1} [ k ] = \frac{{J}_{L 1} [ k ] + {J}_{L 4} [ k ]}{M [ k ]} \qquad ( Equation 50 )$$

$${J}_{L 2} [ k ] = \sqrt{{J}_{L 1}^{2} [ k ] - ( 1 - 2 M [ k ] )} \qquad ( Equation 51 )$$

$${Θ}_{2} [ k ] = {tan}^{- 1} ( \frac{M [ k ]}{{J}_{L 1} [ k ]} ) + {tan}^{- 1} ( \frac{1 - M [ k ]}{{J}_{L 2} [ k ]} ) \qquad ( Equation 52 )$$

$${Θ}_{4} = \frac{π}{2} \qquad ( Equation 53 )$$

$${Θ}_{3} [ k ] = \frac{2 𝔫}{F [ k ]} - ( {Θ}_{1} [ k ] + {Θ}_{2} [ k ] + {Θ}_{4} [ k ] ) \qquad ( Equation 54 )$$

As in equation (33), θ₄ is set to 90°

$$( or \frac{π}{2} )$$

in equation 53. The state plane solver circuit 1408 provides the values of θ₁, θ₂, θ₃, and θ₄ to the angle to interval conversion circuit 1410.

The angle to interval conversion circuit 1410 determines the duration values t_{M}, t_{SR}, t_{dt1}, and t_{dt2} for the charging interval, the discharging interval, the first dead time, and the second dead time based on θ₁, θ₃, θ₂, and θ₄ respectively. The angle to interval conversion circuit 1410 can determine the interval time values t₁, t₂, t₃, and t₄ as:

tⱼ[k]=θⱼ[k]τ[k] j=1 . . . 4 (Equation 55)

where T[k] is the resonant time constant of the power supply system 104 (τ=\sqrt{LC}). Referring again to FIG. 12A, t₁ can correspond to t_{M}, t₂ can correspond to t_{dt1}, t₃ can correspond to t_{SR}, and t₄ can correspond to t_{dt2}. The angle to interval conversion circuit 1410 provides t_{M}, t_{SR}, t_{dt1}, and t_{dt2} to the control logic circuit 1118 for use in generating the control signal 1030 and the control signal 1032.

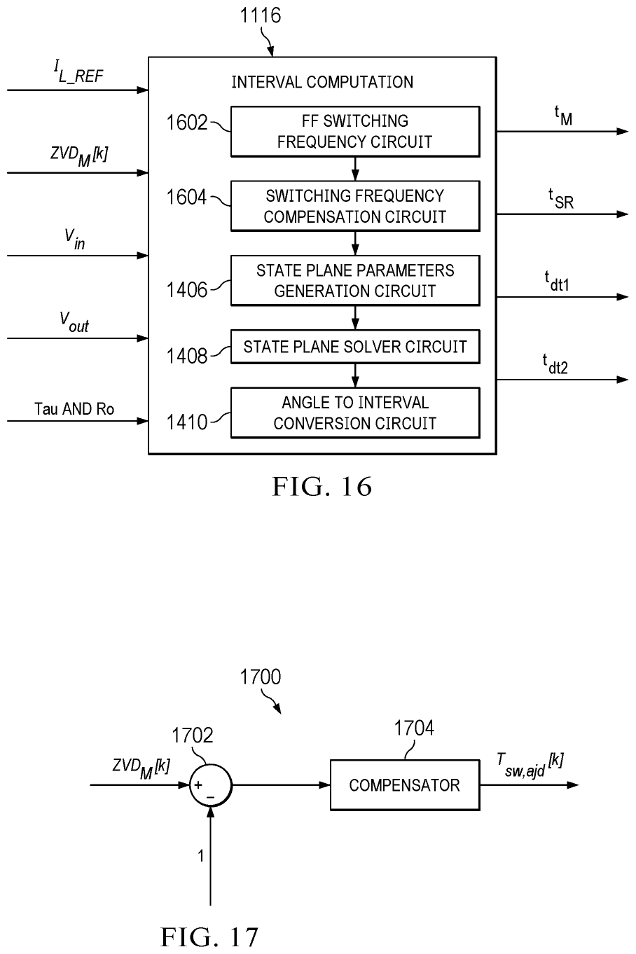

FIG. 16 is a block diagram of an example interval computation circuit 1116 that uses ZVD feedback (an indication of ZVS state or non ZVS state) to tune switching frequency. The interval computation circuit 1116 includes an FF switching frequency circuit 1602, a switching frequency compensation circuit 1604, a state plane parameter generation circuit 1406, a state plane solver circuit 1408, and an angle to interval conversion circuit 1410. The interval computation circuit 1116 receives as input digital values I_{RLEF}, ZVD_{M}[k], V_{IN}, V_{OUT}, Tau (T) and Ro. ZVD_{M} is feedback of ZVD at switching of the main switch (e.g., switch 1008, indication signal 1072 in FIG. 10).

The FF switching frequency circuit 1602 provides an FF switching frequency value (f_{SW,FF}[k]) based on the input values as per equation 41. In some examples, the FF switching frequency circuit 1602 may generate f_{SW,FF}[k] as per equation 42.

The FF switching frequency circuit 1602 provides f_{SW,FF}[k] to the switching frequency compensation circuit 1604 for generating f_{sw}[k]. The switching frequency compensation circuit 1604 can provide f_{sw}[k] as per equation 43.

FIG. 17 is a block diagram of compensation circuitry 1700 of the FF switching frequency circuit 1602 for generation of T_{sw,ajd}[k]. The compensation circuitry 1700 includes a difference circuit 1702 and a compensator circuit 1704. The difference circuit 1702 generates an error signal representing a difference between ZVD_{M}[k] and a logic “1” value (or whether ZVD_{M}[k] is a logic 1 value, or has an asserted state), and provides the error signal to the compensator circuit 1704. The compensator circuit 1704 can include a proportional-integral-derivative (PID) controller (or other control process) that modulates T_{sw,ajd}[k] to a higher value or a lower value based on whether ZVD_{M}[k] is a logic 1 value. For example, the compensator circuit 1704 can decrease T_{sw,ajd}[k] if ZVD_{M}[k] is a logical 1 value, and increase T_{sw,ajd}[k] if ZVD_{M}[k] is not a logical 1 value.

Returning to FIG. 16, the switching frequency compensation circuit 1404 provides T_{sw,ajd}[k] to the state plane parameter generation circuit 1406 for use in generation of the state plane parameters. The state plane parameter generation circuit 1406 can generate the normalized state plane parameters as per equations 44-46.

The state plane parameter generation circuit 1406 provides M[k], J_{L}[k], and F[k] to the state plane solver circuit 1408. The state plane solver circuit 1408 applies the parameter values received from the state plane parameter generation circuit 1406 to solve equations 47-54 for θ₁, θ₃, θ₂, and θ₄.

As in equation (33), θ₄ is set to 90° in equation 53. The state plane solver circuit 1408 provides the values of θ₁, θ₂, θ₃, and θ₄ to the angle to interval conversion circuit 1410.

The angle to interval conversion circuit 1410 determines the time values t_{M}, t_{SR}, t_{dt1}, and t_{dt2} for the charging interval, the discharging interval, the first dead time, and the second dead time based on θ₁, θ₃, θ₂, and θ₄ respectively. The angle to interval conversion circuit 1410 can determine the time values as per equation 40. The angle to interval conversion circuit 1410 provides t_{M}, t_{SR}, t_{dt1}, and t_{dt2} to the control logic circuit 1118 for use in generating the control signal 1030 and the control signal 1032.

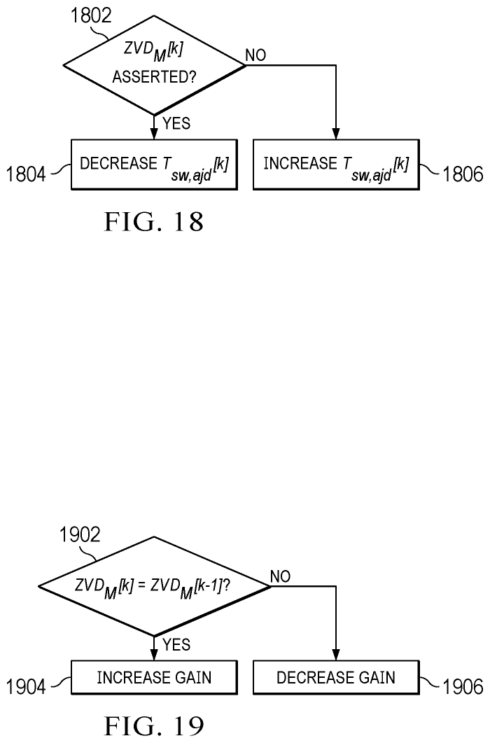

FIG. 18 is flow diagram of a method of determining the switching cycle period adjustment value T_{sw,ajd}[k] in the compensator circuit 1704. In block 1802, the compensator circuit 1704 determines whether ZVD_{M}[k] is a logic 1 value (whether ZVD_{M}[k] is asserted). Responsive to ZVD_{M}[k] being asserted in block 1802, then, in block 1804, the compensator circuit 1704 can decrease the value of T_{sw,ajd}[k] relative to a previous value of T_{sw,ajd}[k].

T_{sw,ajd}[k]=T_{sw,ajd}[k−1]−k_{ZVD}ΔT_{SW} (Equation 56)
where:
ΔT_{SW} is a change value (e.g., 0.5, 1, etc.); and
k_{ZVD} is a gain factor.

Responsive to ZVD_{M}[k] not being asserted in block 1802, then, in block 1806) the compensator circuit 1704 can increase the value of T_{sw,ajd}[k] relative to the previous value of T_{sw,ajd}[k].

T_{sw,ajd}[k]=T_{sw,ajd}[k−1]+k_{ZVD}ΔT_{SW} (Equation 57)

FIG. 19 is flow diagram of a method of gain factor (k_{ZVD}) adjustment in the compensator circuit 1704. In block 1902, the compensator circuit 1704 determines whether a current value of ZVD_{M} (ZVD_{M}[k]) is the same as a prior value of ZVD_{M} (ZVD_{M}[k−1]) (e.g., whether the gain factor is the same in consecutive switching cycles). If the current and prior values of ZVD_{M} are the same in block 1902, then, in block 1904, the compensator circuit 1704 can increase the gain factor (k_{ZVD}) applied to change the value of T_{sw,ajd}[k].

k_{ZVD}=k_{ZVD}+Δk_{ZVD,1} (Equation 58)

where Δk_{ZVD,1} is a change value applied to increase gain.

If the current and prior values of ZVD_{M} are not the same in block 1902, then, in block 1906, the compensator circuit 1704 can decrease the gain factor (k_{ZVD}) applied to change the value of T_{sw,ajd}[k].

k_{ZVD}=k_{ZVD}−Δk_{ZVD,2} (Equation 59)

where Δk_{ZVD,2} is a change value applied to decrease gain.

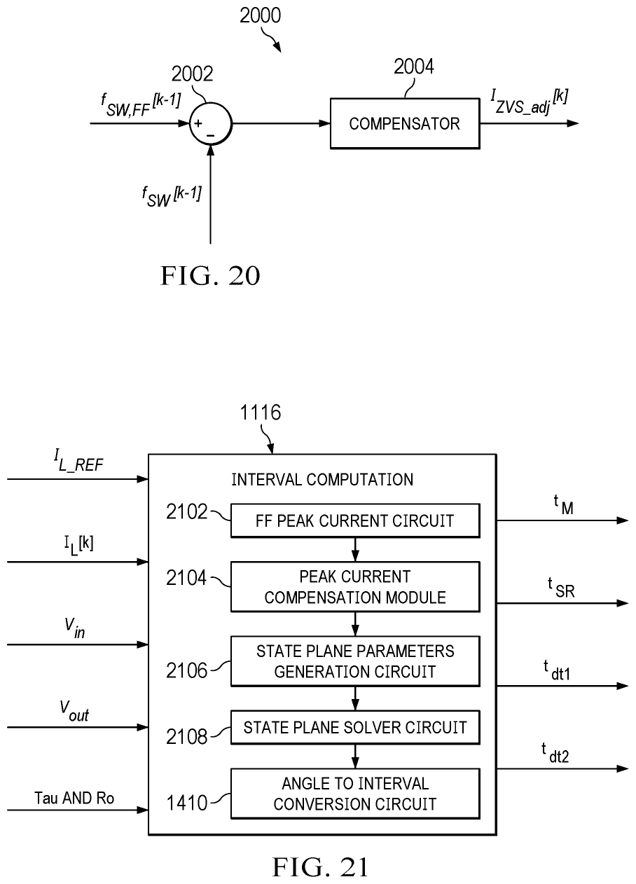

FIG. 20 is a block diagram of compensation circuitry 2000 that can be used to generate I_{ZVS}[k] for computation of f_{SW,FF}[k] in the FF switching frequency circuit 1602 or the FF switching frequency circuit 1402. Using the compensation circuitry 2000, I_{ZVS}[k] can be adaptively adjusted to account for the resonant transition, rather than being a constant as in equation 42. The compensation circuitry 2000 includes a difference circuit 2002 and a compensator circuit 2004. The difference circuit 2002 generates an error signal representing a difference between previous values of switching frequency (f_{SW}[k−1]) and its feed forward component (f_{SW,FF}[k−1]), which can represent additional time provided to account for resonant transition of the switching node. The compensator circuit 2004 can include a proportional-integral-derivative (PID) controller (or other control process) that modulates I_{ZVS}[k] based on the error signal.

The FF switching frequency circuit 1402 or the FF switching frequency circuit 1602 may generate f_{SW,FF}[k] based on adjusted I_{ZVS_adj}[k] as:

$${f}_{sw , FF} [ k ] = \frac{{V}_{IN} [ k ] ( 1 - \frac{{V}_{IN} [ k ]}{{V}_{OUT} [ k ]} )}{2 L ( \vert {i}_{L , REF} [ k ] \vert + {I}_{ZVS\_adj} [ k ] )} \qquad ( Equation 60 )$$

FIG. 21 is a block diagram of an example interval computation circuit 1116 that determines t_{M}, t_{SR}, tdtt, and t_{dt2} based on average inductor current and peak charging current. The interval computation circuit 1116 includes an FF peak current circuit 2102, a peak current compensation module 2104, a state plane parameter generation circuit 2106, a state plane solver circuit 2108, and an angle to interval conversion circuit 1410. The interval computation circuit 1116 receives as input digital values I_{LREF}, I_{L}[k], V_{IN}, V_{OUT}, Tau (T) and Ro.

The FF peak current circuit 2102 provides an FF peak current value (i_{L1,FF}[k]) based on the input values as per equation 61.

i_{L1,FF}[k]=f(v_{IN}[k],v_{OUT}[k],i_{L,REF}[k]) (Equation 61)

In some examples, the FF peak current circuit 2102 may generate i_{L1,FF}[k] as per equation 62.

i_{L1,FF}[k]=2i_{L,REF}[k] (Equation 62)

The FF peak current circuit 2102 provides i_{L1,FF}[k] to the peak current compensation module 2104 for generating i_{L1}[k]. The switching frequency compensation circuit 1604 can provide i_{L1}[k] as:

i_{L1}[k]=i_{L1,COMP}[k]+i_{L1,FF}[k] (Equation 63)

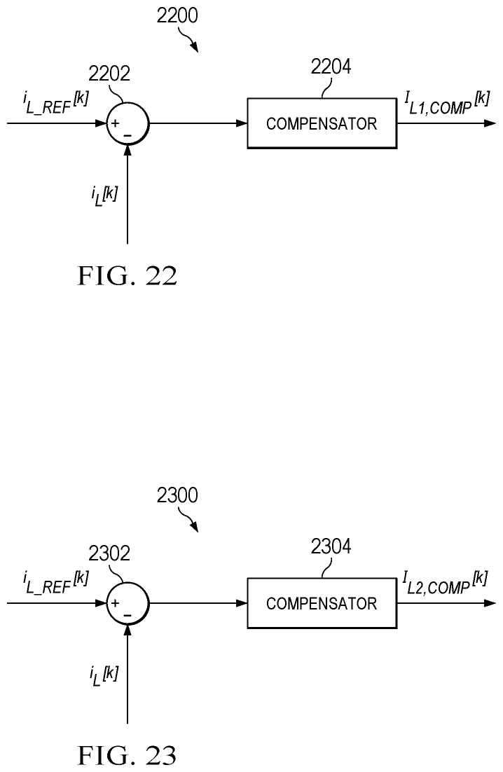

FIG. 22 is a block diagram of compensation circuitry 2200 of the FF peak current circuit 2102 for generation of i_{L1,COMP}[k] used in equation 63. The compensation circuitry 2200 includes a difference circuit 2202 and a compensator circuit 2204. The difference circuit 2202 generates an error signal representing a difference between the average current (i_{L}[k]) and the reference current (i_{L,REF}[k]), and provides the error signal to the compensator circuit 2204. The compensator circuit 2204 can include a proportional-integral-derivative (PID) controller (or other control process) that modulates i_{L1,COMP}[k] based on the error signal to reduce the difference between i_{L}[k] and i_{L,REF}[k].

Returning to FIG. 21, the peak current compensation module 2104 provides i_{L1}[k] to the state plane parameter generation circuit 2106 for use in generation of the state plane parameters. The state plane parameter generation circuit 2106 can generate the normalized state plane parameters M[k] and J_{L}[k] as per equations 44 and 45. The state plane parameter generation circuit 2106 can generate the normalized state plane parameter J_{L1}[k] as:

$${J}_{L 1} [ k ] = \frac{{i}_{L 1} [ k ]}{{v}_{OUT} [ k ]} {R}_{0} \qquad ( Equation 64 )$$

The state plane parameter generation circuit 1406 provides M[k], J_{L}[k], and J_{L1}[k] to the state plane solver circuit 2108. The state plane solver circuit 2108 applies the parameter values received from the state plane parameter generation circuit 2106 to solve equations 65-72 for θ₁, θ₃, θ₂, and θ₄.

$${J}_{L 4} = 1 - M \qquad ( Equation 65 )$$

$${J}_{L 3} = M \qquad ( Equation 66 )$$

$$F [ k ] = \frac{4 π M [ k ] ( 1 - M [ k ] ) {J}_{L} [ k ]}{{J}_{L 1}^{2} [ k ] - {J}_{L 4}^{2} [ k ]} \qquad ( Equation 67 )$$

$${Θ}_{1} [ k ] = \frac{{J}_{L 1} [ k ] + {J}_{L 4} [ k ]}{M [ k ]} \qquad ( Equation 68 )$$

$${J}_{L 2} [ k ] = \sqrt{{J}_{L 1}^{2} [ k ] - ( 1 - 2 M [ k ] )} \qquad ( Equation 69 )$$

$${Θ}_{2} [ k ] = {tan}^{- 1} ( \frac{M [ k ]}{{J}_{L 1} [ k ]} ) + {tan}^{- 1} ( \frac{1 - M [ k ]}{{J}_{L 2} [ k ]} ) \qquad ( Equation 70 )$$

$${Θ}_{4} [ k ] = \frac{π}{2} \qquad ( Equation 71 )$$

$${Θ}_{3} [ k ] = \frac{2 π}{F [ k ]} - ( {Θ}_{1} [ k ] + {Θ}_{2} [ k ] + {Θ}_{4} [ k ] ) \qquad ( Equation 72 )$$

The state plane solver circuit 2108 provides the values of θ₁, θ₂, θ₃, and θ₄ to the angle to interval conversion circuit 1410. The angle to interval conversion circuit 1410 determines the time values t_{M}, t_{SR}, t_{dt1}, and t_{dt2} for the charging interval, the discharging interval, the first dead time, and the second dead time based on θ₁, θ₃, θ₂, and θ₄ respectively. The angle to interval conversion circuit 1410 can determine the time values as per equation 40. The angle to interval conversion circuit 1410 provides t_{M}, t_{SR}, t_{dt1}, and t_{dt2} to the control logic circuit 1118 for use in generating the control signal 1030 and the control signal 1032.

In another example of interval computation circuit 1116, that is similar to that shown in FIG. 21, The FF peak current circuit 2102 provides an FF peak current value (i_{L2,FF}[k]) based on the input values as per equation 73.

i_{L2,FF}[k]=f(v_{IN}[k],v_{OUT}[k],i_{L,REF}[k]) (Equation 73)

In some examples, the FF peak current circuit 2102 may generate i_{L2,FF}[k] as per equation 74.

i_{L2,FF}[k]=2i_{L,REF}[k] (Equation 74)

The FF peak current circuit 2102 provides i_{L2,FF}[k] to the peak current compensation module 2104 for generating i_{L2}[k]. The peak current compensation module 2104 can provide i_{L2}[k] as:

i_{L2}[k]=i_{L2,COMP}[k]+i_{L2,FF}[k] (Equation 75)

where i_{L2,COMP}[k] is provided by the compensation circuitry 2200 (instead of i_{L1,COMP}[k] as shown in FIG. 22).

FIG. 23 is a block diagram of compensation circuitry 2300 of the FF peak current circuit 2102 for generation of i_{L2,COMP}[k] used in equation 75. The compensation circuitry 2300 includes a difference circuit 2302 and a compensator circuit 2304. The difference circuit 2302 generates an error signal representing a difference between the average current (i_{L}[k]) and the reference current (i_{L,REF}[k]), and provides the error signal to the compensator circuit 2304. The compensator circuit 2304 can include a proportional-integral-derivative (PID) controller (or other control process) that modulates i_{L2,COMP}[k] based on the error signal to reduce the difference between i_{L}[k] and i_{L,REF}[k].

The peak current compensation module 2104 provides i_{L2}[k] to the state plane parameter generation circuit 2106 for generation of the state plane parameters. The state plane parameter generation circuit 2106 can generate the normalized state plane parameters M[k] and J_{L}[k] as per equations 44 and 45. The state plane parameter generation circuit 2106 can generate the normalized state plane parameter J_{L2}[k] as:

$${J}_{L 2} [ k ] = \frac{{i}_{L 2} [ k ]}{{v}_{OUT} [ k ]} {R}_{0} \qquad ( Equation 76 )$$

The state plane parameter generation circuit 2106 provides M[k], J_{L}[k], and J_{L1}[k] to the state plane solver circuit 2108. The state plane solver circuit 2108 applies the parameter values received from the state plane parameter generation circuit 2106 to solve equations 77-84 for θ₁, θ₃, θ₂, and θ₄.

$${J}_{L 4} = 1 - M \qquad ( Equation 77 )$$

$${J}_{L 3} = M \qquad ( Equation 78 )$$

$${J}_{L 1} [ k ] = \sqrt{{J}_{L 2}^{2} [ k ] + ( 1 - 2 M [ k ] )} \qquad ( Equation 79 )$$

$$F [ k ] = \frac{4 π M [ k ] ( 1 - M [ k ] ) {J}_{L} [ k ]}{{J}_{L 1}^{2} [ k ] - {J}_{L 4}^{2} [ k ]} \qquad ( Equation 80 )$$

$${Θ}_{1} [ k ] = \frac{{J}_{L 1} [ k ] + {J}_{L 4} [ k ]}{M [ k ]} \qquad ( Equation 81 )$$

$${Θ}_{2} [ k ] = {tan}^{- 1} ( \frac{M [ k ]}{{J}_{L 1} [ k ]} ) + {tan}^{- 1} ( \frac{1 - M [ k ]}{{J}_{L 2} [ k ]} ) \qquad ( Equation 82 )$$

$${Θ}_{4} [ k ] = \frac{π}{2} \qquad ( Equation 83 )$$

$${Θ}_{3} [ k ] = \frac{2 π}{F [ k ]} - ( {Θ}_{1} [ k ] + {Θ}_{2} [ k ] + {Θ}_{4} [ k ] ) \qquad ( Equation 84 )$$

The state plane solver circuit 2108 provides the values of θ₁, θ₂, θ₃, and θ₄ to the angle to interval conversion circuit 1410. The angle to interval conversion circuit 1410 determines the time values t_{M}, t_{SR}, t_{dt1}, and t_{dt2} for the charging interval, the discharging interval, the first dead time, and the second dead time based on θ₁, θ₃, θ₂, and θ₄ respectively. The angle to interval conversion circuit 1410 can determine the time values as per equation 40. The angle to interval conversion circuit 1410 provides t_{M}, t_{SR}, t_{dt1}, and t_{dt2} to the control logic circuit 1118 for use in generating the control signal 1030 and the control signal 1032.

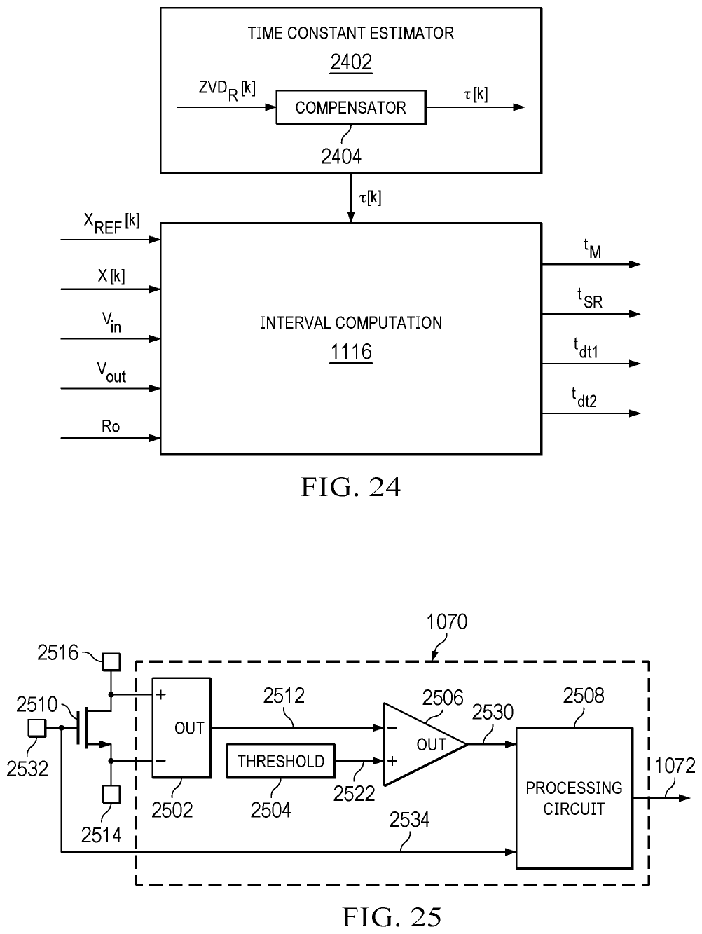

FIG. 24 is a block diagram of an example time constant estimator circuit 2402 used with the interval computation circuit 1116. If the resonant time constant T[k] provided to interval computation circuit 116 does not reflect the actual resonant time constant of power supply system 104 (e.g., the values of L and C provided to the controller 1012 are inaccurate), then the duration values for the intervals t_{M}, t_{SR}, t_{dt1}, and t_{dt2} computed based on T[k] may not be equal to the interval to achieve ZVS. Accordingly, the time constant estimator circuit 2402 can adjust the value of the resonant time constant T[k] based on the detection (or non-detection) of ZVD (ZVD_{R}[k]) at switching of the switch 1010 (indication signal 1072 in FIG. 10), and the interval computation circuit 1116 can use the adjusted resonant time constant to determine the durations of t_{M}, t_{SR}, t_{dt1}, and t_{dt2}. The compensator 2404 can adjust the value of T[k] to achieve ZVS of the power converter rectifier switch (e.g., the switch 1010). The compensator 2404 may include a PID controller, or other control circuit, to adjust T[k]. The time constant estimator circuit 2402 can provide adjusted power converter resonant period T[k] to the interval computation circuit 1116 for use in calculating the time values t_{M}, t_{SR}, t_{dt1}, and t_{dt2}.

FIG. 25 illustrates an example of internal components of transition measurement circuit 1070 and their operations. Transition measurement circuit 1070 can include a voltage measurement circuit 2502, a threshold generator circuit 2504, a comparator 2506, and processing circuit 2508. Voltage measurement circuit 2502 can be coupled across a main switch 2510 of a power converter, which can be one of switches 1008 or 1010, to measure a voltage difference across main switch 1010. In a case where main switch 2510 includes a FET, voltage measurement circuit 2502 can provide a voltage signal 2512 based on a voltage difference between current terminals 2514 and 2516 (e.g., drain and source terminals) of the FET, where current terminal 2514 can be coupled to ground and current terminal 2516 can be coupled to a switching node (e.g., switching node 1014) and to an inductor (e.g., inductor 306). In some examples, voltage measurement circuit 2502 can include a differential amplifier to generate voltage signal 2512. Also, threshold generator circuit 2504 can output a threshold voltage 2522 representing a zero voltage difference across main switch 2510. Threshold voltage 2522 can be a voltage signal 2512 provided by voltage measurement circuit 2502 when the voltage difference is zero. Comparator 2506 can compare voltage signal 2512 against threshold voltage 2522 to provide a decision signal 2530, which indicates whether the voltage difference across main switch 2510 is zero. In the example of FIG. 25, comparator 2506 can provide a logical one for decision signal 2530 if the voltage difference between current terminals 2514 and 2516 equals or below zero, and provide a logical zero for decision signal 2530 if the voltage difference between current terminals 2514 and 2516 exceeds zero.

Also, processing circuit 2508 can be coupled to a control terminal 2532 of main switch 2510 (e.g., a gate terminal) and the output of comparator 2506. Processing circuit 2508 can generate indication signal 1072 based on decision signal 2530 and a control signal 2534 (e.g., one of V_{G1} or V_{G2}) at control terminal 2532, to indicate whether main switch 2510 switches state after switching node 1014 transitions completely to ground, therefore there is a zero voltage difference across main switch 2510 and ZVS can be achieved. In some examples, processing circuit 2508 can include a pulse generator circuit.

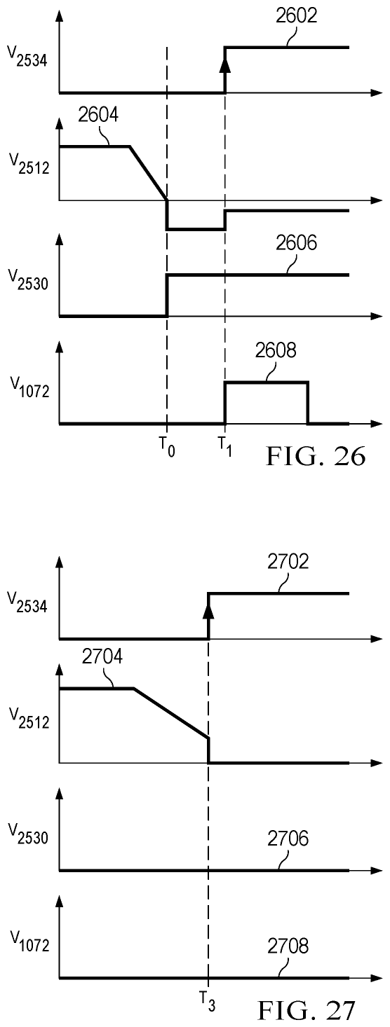

FIG. 26 and FIG. 27 illustrate graphs of signals 2512, 2534, 2530, and indication signal 1072 with respect to time, where indication signal 1072 is provided by the example transition measurement circuit 1070 of FIG. 25. FIG. 26 illustrates graphs 2602, 2604, 2606, and 2608 of, respectively, signals 2512, 2534, 2530, and indication signal 1072 in a case where indication signal 1072 indicates ZVS, and FIG. 27 illustrates graphs 2702, 2704, 2706, and 2708 of, respectively, signals 2512, 2534, 2530, and 1072 in a case where indication signal 1072 indicates non-ZVS.

Referring to FIG. 26, at time T₀, the voltage difference across main switch 2510 drops below zero, and signal 2512 also drops below threshold voltage 2522. This causes decision signal 2530 to be asserted at time T₀. The asserted decision signal 2530 can enable the pulse generator of transition measurement circuit 1070. At time T₁ after T₀, control signal 2534 changes from the second state to the first state to enable main switch 2510. The rising edge of control signal 2534 at T₁ can trigger the pulse generator to generate a pulse for indication signal 1072, and the pulse can indicate a ZVS condition, as main switch 2510 changes state when the voltage across the main switch is zero.

Referring to FIG. 27, at time T₃, control signal 2534 changes from the second state to the first state to enable main switch 2510 when the voltage difference across main switch 2510 is still above zero, and signal 2512 is above threshold voltage 2522. This causes decision signal 2530 to be de-asserted, which can disable the pulse generator of transition measurement circuit 1070. Accordingly, indication signal 1072 can be de-asserted, which can indicate a non-ZVS condition as main switch 2510 changes state when the voltage across the main switch is above zero.

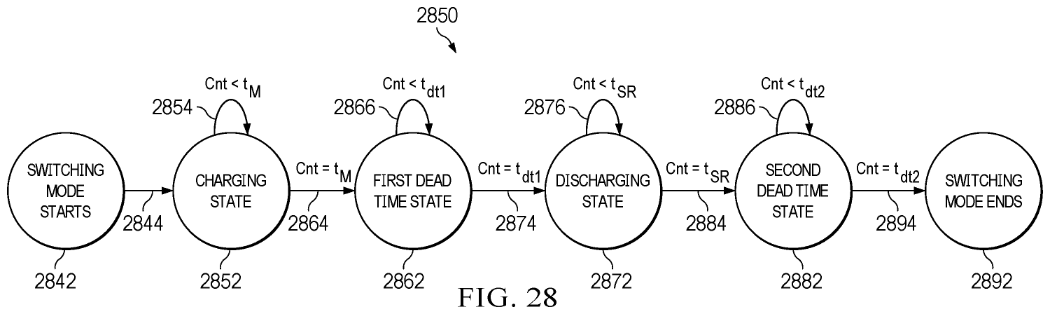

FIG. 28 illustrates an example state diagram 2850 of a state machine in control logic circuit 1118 when operating in the switching mode. Control logic circuit 1118 can reset a counter, and start in a state 2842 when switching mode starts. In some examples, control logic circuit 1118 can receive digital values 1136, 1128, 1140 and 1142 representing, respectively, t_{M}, t_{SR}, t_{dt1}, and t_{dt2} while in state 2842. After receiving the digital values, control logic circuit 1118 can proceed to a charging state 2852 via an edge 2844.

When in charging state 2852, control logic circuit 1118 can first reset the counter, and control PWM generator circuit 1114 to set the control signal of the main switch (e.g., switch 1008) in the first state to enable the main switch, and set the control signal for the SR switch (e.g., switch 1010) in the second state to disable the SR switch. The counter can increment with respect to time, and control logic circuit 1118/PWM generator circuit 1114 can remain in the charging state when the counter value is below digital value 1136 representing t_{M}, as indicated by a transition edge 2854.

When the counter value matches digital values 1124/1136, control logic circuit 1118 can reset the counter and transition to a first dead time state 2862 via a transition edge 2864. Within first dead time state 2862, PWM generator circuit 1114 sets both V_{G1} and V_{G2} to the second state. The counter can increment with respect to time after the reset is released, and control logic circuit 1118/PWM generator circuit 1114 can remain in the first dead time state when the counter value is below digital value 1140 representing the duration of the first dead time interval t_{dt1}, as indicated by a transition edge 2866.

When the counter value matches digital value 1140, control logic circuit 1118 can reset the counter and transition to a discharging state 2872 via a transition edge 2874. In discharging state 2872, PWM generator circuit 1114 can set the control signal of the main switch (e.g., switch 1008) in the second state to disable the main switch, and set the control signal of the SR switch (e.g., switch 1010) to the first state to enable the SR switch. The counter can increment with respect to time after the reset is released, and control logic circuit 1118/PWM generator circuit 1114 can remain in the discharging state when the counter value is below digital value 1128 representing the duration of the discharging interval t_{SR}, as indicated by a transition edge 2876.

When the counter value matches digital value 1128, control logic circuit 1118 can reset the counter and transition to a second dead time state 2882 via a transition edge 2884. Within second dead time state 2882, PWM generator circuit 1114 sets both control signals V_{G1} and V_{G2} to low. The counter can increment with respect to time after the reset is released, and PWM generator circuit 1114 can remain in the first dead time state when the counter value is below digital value 1142 representing the duration of the second dead time interval t_{dt2}, as indicated by a transition edge 2886. When the counter value reaches digital value 1142, control logic circuit 1118 can enter state 2892 where the switching mode ends via edge 2894.

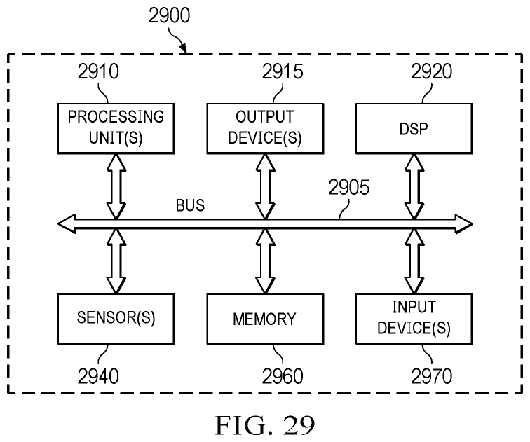

FIG. 29 illustrates an embodiment of a hardware system 2900, which may be used as described herein above. For example, hardware system 2900 can implement the functions of controller 1012. FIG. 29 provides only a generalized illustration of various components, any, or all of which may be used as appropriate.

Hardware system 2900 is shown comprising hardware elements that can be electrically coupled via a bus 2905 (or may otherwise be in communication, as appropriate). The hardware elements may include a processing unit(s) 2910 which can include without limitation one or more general-purpose processors, one or more special-purpose processors (such as digital signal processing (DSP) chips, graphics acceleration processors, application specific integrated circuits (ASICs), and/or the like), and/or other processing structure or means. For example, processing unit(s) 2910 can perform computations according to Equations 26-84 as described above. As shown in FIG. 29, some embodiments may have a separate Digital Signal Processor (DSP) 2920, depending on desired functionality. For example, DSP 2920 can process measurements 1040 of the output voltage and measurements 1050 of the input voltage of power converter circuit 122. In some examples, hardware system 2900 can include one or more input devices 2970, which can include devices related to user interface (e.g., a touch screen, touch pad, microphone, button(s), dial(s), switch(es), and/or the like). Similarly, the one or more output devices 2915 may be related to interacting with a user (e.g., via a display, light emitting diode(s) (LED(s)), speaker(s)). Hardware system 2900 can further include sensor(s) 2940. For example, sensor(s) 2940 can include various components of transition measurement circuit 1070.

Hardware system 2900 may further include and/or be in communication with a memory 2960. Memory 2960 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

In some examples, memory 2960 may provide memory 1120 of FIG. 11 to provide storage to support the computations according to Equations 26-84. Memory 2960 can also include software elements (not shown in FIG. 29), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the operations described herein may be implemented as code and/or instructions in memory 2960 that are executable by hardware system 2900 (and/or processing unit(s) 2910 or DSP 2920 within hardware system 2900). In an aspect, then, such code and/or instructions can be used to configure and/or adapt a general-purpose computer (or other device) to perform one or more operations described herein.

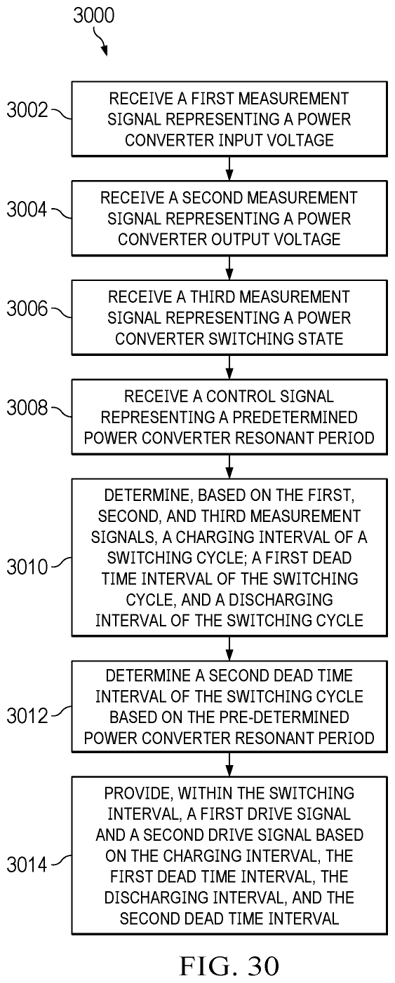

FIG. 30 includes a flowchart of an example method 3000 of controlling a power converter circuit, such as power converter circuit 122 of FIGS. 3, 6, and 10. For example, method 3000 can be performed by controller 1012. The power converter circuit can include an inductor (e.g., inductor 306), a first switch (e.g., one of switches 308, 602/604, or 1008), and a second switch (e.g., one of switches 310, 604/602, or 1010). The inductor and first and second switches can be coupled at a switching node (e.g., one of nodes 314, 614, or 1014), and the first and second switches can be coupled in series between a positive output and a negative output of the power converter. The first switch can operate as the main switch and the second switch can operate as the SR switch.

The power converter can be part of a power supply system (e.g., power supply system 104) that further includes a first measurement circuit (e.g., one of measurement circuits 352, 662, or 1052) coupled across the positive input and the negative input to measure the input voltage to the power converter and a second measurement circuit (e.g., one of measurement circuits 342, 652, or 1042) to measure the output voltage of the power converter. The power supply system 104 can also include a third measurement circuit to measure inductor current or a status of transition of the switching node voltage (e.g., transition measurement circuit 1070). An example of the transition measurement circuit 1070 is shown in FIG. 25. In some examples, the third measurement circuit can be coupled to first and second current terminals of one of the first or second switches, as shown in FIG. 25. In some examples, the third measurement circuit can be coupled to first and second current terminals of both of the first or second switches. In some examples, the third measurement circuit can be coupled to the switching node.

In step 3002, the controller receives, from the first measurement circuit, a first measurement of an input voltage to the power converter, which can be part of a power converter state. The first measurement can include a digital value generated by an ADC of the first measurement circuit, and the first measurement can indicate the magnitude and polarities of the input voltage of a current switching cycle.

In step 3004, the controller receives, from the second measurement circuit, a second measurement of the output voltage to the power converter, which can be part of the power converter state. The second measurement can include a digital value generated by an ADC of the second measurement circuit, and the second measurement can indicate the magnitude of the output voltage.

In step 3006, the controller receives, from the third measurement circuit coupled to a current terminal of a first switch of the power converter, a current terminal of a second switch of the power converter, and/or an inductor of the power converter, a third measurement signal. The third measurement signal can indicate a voltage across the first switch when the first switch changes states. The indication signal can indicate whether the voltage completes transition to a target voltage (e.g., ground, the output voltage), such that the voltage difference across the main switch (first or second switches) is zero or below zero when the main switch changes state, and whether ZVS is detected. In some examples the third measurement signal can represent a current (e.g., an average current) flowing in the inductor. The detection of ZVS or non-ZVS, and the average current flowing in the inductor, can be part of the power converter state.

In step 3008, the controller receives a control signal representing a predetermined power converter resonant period. The resonant period can be computed based on a specified inductance of the inductor and a specified capacitance at the switching node in some examples. In some examples, the resonant period can be adaptively determined based on a ZVD signal measured at switching of the rectifier switch (e.g., switch 1010) as shown in FIG. 24.

In step 3010, the controller can determine, based on the first, second, and third measurement signals, a charging interval of a switching cycle in which the inductor is charged, a discharging interval of the switching cycle in which the inductor is discharged, and a first dead time interval that follows the charging interval and precedes the discharging interval. For example, the controller can determine values of θ₁, θ₂, θ₃ by solving equations 26-33, equations 44-54, equations 64-72, or equations 76-84. The controller can use the values of θ₁, θ₂, θ₃ to solve equation 40 and determine the value of t_{M}, t_{SR}, and t_{dt1}.

In step 3012, the controller can determine, based on the predetermined power converter resonant period, a second dead time interval that follows the discharging interval and precedes the charging interval. For example, the controller can set θ₄ to π/2 as in equations 33, 53, 71, or 83. The controller can use the value of θ₄ to solve equation 40 and determine the value of t_{dt2}.

In step 3014, the controller can provide a first drive signal and a second drive signal based on the charging interval, the discharging interval, the first dead time interval, and the second dead time interval. For example, the interval computation circuit 1116 can provide t_{M}, t_{SR}, and t_{dt1}, and t_{dt2} to the control logic circuit 1118. The control logic circuit 1118 can control the PWM generator circuit 1114 to generate V_{G1} and V_{G2} to control switching of the first switch and the second switch.

Within the charging interval, the controller can enable the first switch and disable the second switch to charge the inductor with the input current, and the inductor current increases to reach a peak current at the end of the charging interval. The controller can set a first control signal at a first state (e.g., a gate voltage higher than the source voltage by a conduction threshold of an NFET of the first switch) to enable the first switch, and set a second control signal at a second state (e.g., a gate voltage below a sum of the source voltage and the conduction threshold of an NFET of the second switch) to disable the second switch.

Within the first dead time interval after the charging interval, the controller can disable both the first and second switches. The controller can set both the first control signal and the second control signal at the second state to disable both the first and second switches.

Within the discharging interval after the first dead time interval, the controller can disable the first switch and enable the second switch to discharge the inductor to provide an output current to the load, and the inductor current drops from the peak current to a SR turn-off current when the discharging interval ends. The SR turn-off current can be zero or a negative current. The controller can set the first control signal at the second state to disable the first switch, and set the second control signal at the first state to enable the second switch.

Within the second dead time interval after the discharging interval, the controller can set both the first control signal and the second control signal at the second state to disable both the first and second switches.

The controller 1012 provides unified control that guarantees accurate, optimal dead times for ZVS of both, main and rectifier switch in a ZVS-Quasi-Square-Wave (QSW) converter, with precise average inductor current control. Current and voltage waveshapes provided by the controller 1012 are beneficial from the hardware design, and efficiency optimization standpoint. The existing control techniques have limited performance, due to their reliance on high bandwidth current sensors, or open-loop control based on approximate equations, or look-up tables. Inaccuracy of the control can result in poor tracking of the current reference, but more importantly, loss of ZVS in both, main and rectifier device, which can lead to significant loss in the semiconductor devices, especially in high frequency designs.

A ZVS-QSW converter is described with a system of transcendental equations. The set of solutions can only be found using an iterative numerical method that is nonviable for real-time implementation. The controller 1012 sets the angle of valley resonant transition interval to 90°, and uses a mathematical identity to simplify, and to analytically solve the set of equations. This yields an exact solution for waveforms and timings for a ZVS-QSW converter, with a constraint that valley resonant transition interval angle (θ₄) is set to 90°. The calculated timings are used to generate gate pulses.

Inputs to the controller 1012 can be the inductor current reference, input and output voltage of the converter, and ZVD signal of the main switch. The dead time before turning on the main switch is kept fixed to a value that corresponds to 90° valley resonant transition interval angle (θ₄). The equations assume a switching frequency, based on an approximate estimate. Using the aforementioned analytical solution, the timings are calculated, and the gate pulses are applied accordingly. Switching frequency can be adaptively adjusted based on, for example, the ZVD signal. Once the switching frequency is tuned to achieve ZVS, the average inductor current can equal the current reference, and the dead times computed by the controller 1012 can correspond to the durations of the resonant transition intervals.

The algorithms/methods implemented by controller 1012 in determining t_{M}, t_{SR}, t_{dt1}, and t_{dt2}, as described in FIGS. 11-30 can provide various benefits. Specifically, the controller 1012 can determine exact analytical solutions without using iterative numerical methods, which can reduce the computation and memory resources involved in the computation of t_{M}, t_{SR}, t_{dt1}, and t_{dt2} and allow these interval values to be computed and updated in real time. Also, because exact analytical solutions are determined, the dead time intervals and switching frequency for ZVS can be more accurately determined, which can reduce hard switching, as well as third-quadrant conduction loss, thus increasing (or even maximizing) the performance of the semiconductor switching devices. The controller 1012 provides ZVS at all operating points resulting in low loss. The controller 1012 can also provide low total harmonic distortion (THD) due to reduced delay in computation/adjustment of t_{M}, t_{SR}, t_{dt1}, and t_{dt2} during light load condition. For example, THD can be about 9% at no load and less than 4% at full load. The controller 1012 can provide excellent transient response and no-load operation (e.g., low dissipation without burst or discontinuous mode operation).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” means that the conduction channel of the FET is present and drain current may flow through the FET. References herein to a FET being “off” means that the conduction channel is not present and drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. An apparatus comprising:
a controller circuit having first and second control inputs, and first and second control outputs, in which the controller circuit is configured to:
at the first control input, receive a measurement signal representing a power converter state;
at the second control input, receive a control signal representing a power converter resonant period;
based on the power converter state and the power converter resonant period, determine: a charging interval of a switching cycle; a first dead time interval of the switching cycle; a discharging interval of the switching cycle, and a second dead time interval of the switching cycle, in which the first dead time interval is after the charging interval, the discharging interval is after the first dead time interval, and the second dead time interval is after the discharging interval;
within the switching cycle, provide a first drive signal at the first control output, and provide a second drive signal at the second control output, in which:
within the charging interval, the first drive signal has a first state, and the second drive signal has a second state;
within the first and second dead time intervals, the first and second drive signals have the second state; and
within the discharging interval, the first drive signal has the second state, and the second drive signal has the first state.

2. The apparatus of claim 1, wherein:
the first control output is coupled to a first power converter control terminal;
the second control output is coupled to a second power converter control terminal; and
the first state is opposite to the second state.

3. The apparatus of claim 1, wherein the power converter state indicates at least one of: a zero voltage switching (ZVS) state of a prior switching cycle, a non ZVS state of the prior switching cycle, an average power converter current of the prior switching cycle, a peak current within the charging interval of the prior switching cycle, a peak current of the discharging interval within the prior switching cycle, a power converter input voltage of the prior switching cycle, or a power converter output voltage of the prior switching cycle.

4. The apparatus of claim 3, wherein the controller circuit is configured to determine the second dead time interval based on a quarter of the power converter resonant period.

5. The apparatus of claim 4, wherein the measurement signal is a first measurement signal, the controller circuit has third and fourth control inputs, and the controller circuit is configured to:
receive a second measurement signal representing the power converter input voltage at the third control input;
receive a third measurement signal representing the power converter output voltage at the fourth control input; and
determine the charging interval, the discharging interval, and the first dead time interval based on the power converter input and output voltages.

6. The apparatus of claim 5, wherein the controller circuit has a fifth control input and a sixth control input, and the controller circuit is configured to:
receive a reference signal representing a target power converter current at the fifth control input;
receive a second control signal representing a power converter resonant impedance at the sixth control input;
determine an operation parameter signal based on the first, second, and third measurement signals and the reference signal; and
determine the charging interval, the first dead time interval, and the discharging interval based on the operation parameter signal, the second dead time interval, and the power converter resonant impedance.

7. The apparatus of claim 6, wherein the operation parameter signal indicates a period of the switching cycle, and the controller circuit configured:
determine a feedforward component of the period based on the power converter input and output voltages;
determine a feedback component of the period based on the power converter state; and
determine the charging interval, the first dead time interval, and the discharging interval based on the period, the second dead time interval, the power converter resonant period, and the power converter resonant impedance.

8. The apparatus of claim 7, wherein the controller circuit is configured to:
decrease the feedback component responsive to the power converter state indicating the ZVS state; and
increase the feedback component responsive to the power converter state indicating the non ZVS state.

9. The apparatus of claim 8, wherein the controller circuit is configured to:
determine a gain factor based on whether the power converter state indicates the ZVS state in consecutive switching cycles; and
increase or decrease the feedback component based on the gain factor.

10. The apparatus of claim 7, wherein the target power converter current represents a target average power converter current, and the controller circuit is configured to:
decrease the feedback component responsive to the power converter state indicating that an average inductor current is above the target average power converter current; and
increase the feedback component responsive to the power converter state indicating that the average inductor current is below the target average power converter current.

11. The apparatus of claim 6, wherein the operation parameter signal indicates a peak current within the charging interval, and the controller circuit is configured to:
determine a feedforward component of the peak current based on the power converter input and output voltages;
determine a feedback component of the peak current based on the power converter state; and
determine the charging interval, the first dead time interval, and the discharging interval based on the peak current, the second dead time interval, the power converter resonant period, and the power converter resonant impedance.

12. The apparatus of claim 6, wherein the controller circuit includes:
a feedforward circuit having first, second, and third feedforward inputs and a feedforward output, the first feedforward input coupled to the first control input, the second feedforward input coupled to the second control input, the third feedforward input coupled to the fifth control input;
a feedback circuit having first, second, third, fourth, fifth, and sixth feedback inputs and parameter outputs, the first feedback input coupled to the first control input, the second feedback input coupled to the second control input, the third feedback input coupled to the third control input, the fourth feedback input coupled to the fourth control input, the fifth feedback input coupled to the fifth control input, the sixth feedback input coupled to the sixth control input;
a state plane solver circuit having solver inputs and first, second, third, and fourth solver outputs, the solver inputs coupled to the parameter outputs;
an angle to interval conversion circuit having first, second, third, and fourth angle inputs and first, second, third, and fourth interval outputs, the first angle input coupled to the first solver output, the second angle input coupled to the second solver output, the third angle input coupled to the third solver output, the fourth angle input coupled to the fourth solver output; and
a pulse width modulation (PWM) generator circuit having first, second, third, and fourth interval inputs and first and second PWM outputs, the first interval input coupled to the first interval output, the second interval input coupled to the second interval output, the third interval input coupled to the third interval output, the fourth interval input coupled to the fourth interval output, the first PWM output coupled to the first control output, and the second PWM output coupled to the second control output.

13. The apparatus of claim 12, wherein:
the feedforward circuit is configured to provide a feedforward component of the operation parameter signal at the feedforward output based on the power converter input and output voltages and the reference signal;
the feedback circuit is configured to:
determine a feedback component of the operation parameter signal based on the power converter state and the reference signal;
provide the operation parameter signal based on combining the feedforward and feedback components; and
provide state plane parameters at the parameter outputs based on the power converter input and output voltages, the reference signal, the operation parameter signal having the feedforward and feedback components, and at least one of the power converter resonant period or the power converter resonant impedance;
the state plane solver circuit is configured to:
determine a first angle, a second angle, and a third angle based on the state plane parameters and a fourth angle being equal to 90 degrees; and
provide the first, second, third, and fourth angles at respective first, second, third, and fourth solver outputs; and
the angle to interval conversion circuit is configured to:
provide the charging interval at the first interval output based on the first angle and the power converter resonant period;
provide the first dead time interval at the second interval output based on the second angle and the power converter resonant period; and
provide the discharging interval at the third interval output based on the third angle and the power converter resonant period; and
provide the second dead time interval at the fourth interval output based on the fourth angle and the power converter resonant period.

14. The apparatus of claim 3, wherein the ZVS state and the non ZVS state are of a power converter main switch.

15. The apparatus of claim 3, wherein the power converter state indicates one of: the ZVS state of a power converter rectifier switch, or the non ZVS state of the power converter rectifier switch; and
wherein the controller circuit is configured to:
determine an adjusted power converter resonant period based on the power converter resonant period and the power converter state; and
determine the second dead time interval of the switching cycle based on the adjusted power converter resonant period.

16. A method comprising:
receiving a measurement signal representing a power converter state;
receiving a control signal representing a power converter resonant period;
determining, based on the power converter state and the power converter resonant period: a charging interval of a switching cycle; a first dead time interval of the switching cycle; a discharging interval of the switching cycle; and a second dead time interval of the switching cycle, in which the first dead time interval is after the charging interval, the discharging interval is after the first dead time interval, and the second dead time interval is after the discharging interval; and
providing, within the switching cycle, a first drive signal and a second drive signal, in which:
within the charging interval, the first drive signal has a first state, and the second drive signal has a second state;
within the first and second dead time intervals, the first and second drive signals have the second state; and
within the discharging interval, the first drive signal has the second state, and the second drive signal has the first state.

17. The method of claim 16, wherein the power converter state indicates at least one of: a zero voltage switching (ZVS) state of a prior switching cycle, a non ZVS state of the prior switching cycle, an average power converter current of the prior switching cycle, a peak current within the charging interval of the prior switching cycle, a peak current of the discharging interval within the prior switching cycle, a power converter input voltage of the prior switching cycle, or a power converter output voltage of the prior switching cycle.

18. The method of claim 16, further comprising determining the second dead time interval based on a quarter of the power converter resonant period.

19. The method of claim 16, wherein:
the control signal is a first control signal; and
the method further comprises:
receiving a reference signal representing a target power converter current;
receiving a second control signal representing a power converter resonant impedance;
determining an operation parameter signal based on the power converter state, the power converter input and output voltages, and the reference signal; and
determining the charging interval, the first dead time interval, and the discharging interval based on the operation parameter signal, the second dead time interval, and the power converter resonant impedance.

20. An apparatus comprising:
a power converter having a positive input, a negative input, a positive output, and a negative output, the power converter including a first switch, a second switch, and an inductor, the first switch and the second switch coupled in series between the positive and negative outputs, and a first current terminal of the first switch coupled to a second current terminal of the second switch and the inductor; and
a controller circuit configured to:
receive a measurement signal representing a state of the power converter;
receive a control signal representing a resonant period of the power converter;
determine, based on the state of the power converter and resonant period of the power converter: a charging interval of a switching cycle of the power converter; a first dead time interval of the switching cycle; a discharging interval of the switching cycle; and a second dead time interval of the switching cycle, in which the first dead time interval is after the charging interval, the discharging interval is after the first dead time interval; and the second dead time interval is after the discharging interval;
within the switching cycle, provide a first drive signal to the first switch, and provide a second drive signal to the second switch, in which:
within the charging interval, the first drive signal has a first state, and the second drive signal has a second state;
within the first and second dead time intervals, the first and second drive signals have the second state; and
within the discharging interval, the first drive signal has the second state, and the second drive signal has the first state.

21. The apparatus of claim 20, wherein the controller circuit is configured to determine the second dead time interval based on a quarter of the resonant period of the power converter.
